(19) United States
(12) Patent Application Publication
(10) Pub. No.: US 2026/0239154 A1
(43) Pub. Date: Aug. 13, 2026

(54) METHOD, APPARATUS AND COMPUTER PROGRAM

(71) Applicant: Nokia Technologies Oy, Espoo (FI)

(72) Inventors: Umur KARABULUT, Munich (DE); Ahmad AWADA, Munich (DE); Halit Murat GÜRSU, Munich (DE); Srinivasan SELVAGANAPATHY, Bangalore (IN); Frédéric RATOVELOMANANA, Massy (FR); Ayaz AHMED, Bangalore (IN); Krzysztof KORDYBACH, Wroclaw (PL)

(21) Appl. No.: 19/154,836

(22) PCT Filed: Mar. 6, 2024
(86) PCT No.: PCT/EP2024/055860

§ 371 Date: Aug. 8, 2025

(30) Foreign Application Priority Data
Apr. 6, 2023 (IN) 202341026093

(51) Int. Cl. H04W 36/36; H04W 36/00

(52) U.S. Cl. CPC H04W 36/362; H04W 36/0069

(57) ABSTRACT

There is provided an apparatus for a target master node comprising: means for determining a first identity and a second identity for conditional reconfigurations associated with, or to be associated with, respective first and second conditional procedures. A first configuration for the first conditional procedure comprises a configuration for: a conditional handover to a primary cell, PCell, of the target master node and a conditional primary secondary cell group cell, PSCell, change/addition to a first PSCell of a first target secondary node. A second configuration for the second conditional procedure comprises a configuration for: a conditional handover to the PCell of the target master node and a conditional PSCell change/addition to a second PSCell of the first or a second target secondary node, the first and the second PSCells being different cells. The apparatus comprising means for receiving, from the user equipment, information about a selected identity for conditional reconfiguration, and means for determining, based on the received information, a PSCell that the user equipment has connected to.

### FIELD

The present application relates to a method, apparatus, and computer program for a wireless communication system.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

A feature of modern communication systems is conditional Handover (CHO) in Multi-RAT Dual Connectivity (MR-DC). Dual connectivity is a feature that enables a UE to connect to two base stations simultaneously. These two base stations may be referred to as a Master Node (MN) and Secondary Node (SN).

### SUMMARY

According to an aspect, there is provided an apparatus for a target master node, the apparatus comprising: means for determining: configurations for at least two conditional procedures for a user equipment connected to a source master node and a source secondary node; means for determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; means for receiving, from the user equipment, information about a selected identity for conditional reconfiguration; and means for determining, based on the received information, a PSCell that the user equipment has connected to.

In an example, the means for determining the PSCell comprises: means for determining, based on the received information and the associations, a PSCell that the user equipment has connected to.

In an example, each of the first and second configurations comprises a configuration for: a conditional handover, and at least two conditional PSCell change/additions.

In an example, the means for determining a first identity and a second identity for conditional reconfigurations associated with, or to be associated with, respective first and second conditional procedures comprises: means for receiving, from a second base station, provisional identities for conditional reconfigurations for PSCells; and means for providing, to the second base station, the first configuration with the associated first identity, and the second configuration with the associated second identity.

In an example, the means for determining a first identity and a second identity for conditional reconfigurations associated with, or to be associated with, respective first and second conditional procedures comprises: means for providing, to a second base station, first information indicating that: the first configuration is for a conditional PSCell change/addition to the first PSCell, and the second configuration is for a conditional PSCell change/addition to the second PSCell; and means for receiving, from the second base station, second information indicating that the first configuration is associated with the first identity, and the second configuration is associated with the second identity.

In an example, the means for determining associations comprises: means for providing, to a second base station, a unique identity for each of the first and second configurations; and means for receiving, from the second base station, a mapping between the unique identities and the first and second identities for conditional reconfigurations.

In an example, the means for determining associations: means for receiving, from a second base station, the first and second identities for conditional reconfigurations; means for determining a mapping between the first and second identities for conditional reconfigurations and unique identities; and means for providing the mapping to the second base station.

In an example, the means for determining the PSCell comprises: means for determining, based on the mapping and the received information, the PSCell that the user equipment has connected to.

In an example, the identities for conditional reconfigurations are secondary cell group identities, wherein the means for determining a first identity and a second identity for conditional reconfigurations associated with, or to be associated with, respective first and second conditional procedures comprises: means for assigning a secondary cell group identity for each of the first and second configurations; means for providing, to a second base station, the first configuration with an associated first secondary cell group identity, and the second configuration with an associated second secondary cell group identity.

In an example, the information about the selected identity is received in a radio resource control reconfiguration complete message from the user equipment.

In an example, the apparatus comprises at least one of: means for, based on the determined PSCell that the user equipment has connected to, initiating a release procedure towards at least one target secondary node; means for, based on the determined PSCell that the user equipment has connected to, providing data forwarding to at least one target secondary node associated with the executed configuration; means for, based on the determined PSCell that the user equipment has connected to, activating at least one data bearers that is associated with the executed configuration.

In an example, the apparatus comprises: means for, in response to receiving a radio resource control reconfiguration complete message without information about a selected identity for a conditional reconfiguration from the user equipment, initiating a release procedure towards all target secondary nodes associated with the configurations for the at least two conditional procedures.

In an example, the apparatus comprises: means for determining information about the PSCell that the user equipment has connected to; and means for providing, to the second base station, the information about the PSCell.

In an example, the information about the PSCell is provided in a handover success message.

In an example, one of: the apparatus is for a first base station, the apparatus is comprised in the first base station, and the apparatus is the first base station.

In an example, the first base station is configured as a target master node.

According to an aspect, there is provided an apparatus for a source master node, the apparatus comprising: means for determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; means for providing, to one of: a user equipment and a first base station, information related to the determined first identity and second identity for conditional reconfigurations associated with, or to be associated with, respective first and second conditional procedures; and means for providing, to the user equipment, the first configuration for the first conditional procedure and the second configuration for the second conditional procedure.

In an example, each of the first and second configurations comprises a configuration for: a conditional handover, and at least two conditional PSCell change/additions.

In an example, the means for determining a first identity and a second identity for conditional reconfigurations associated with, or to be associated with, respective first and second conditional procedures comprises: means for providing, to the first base station, provisional identities for conditional reconfigurations for PSCells; and means for receiving, from the first base station, the first configuration with the associated first identity, and the second configuration with the associated second identity.

In an example, the means for determining a first identity and a second identity for conditional reconfigurations associated with, or to be associated with, respective first and second conditional procedures comprises: means for receiving, from the first base station, first information indicating that: the first configuration is for a conditional PSCell change/addition to the first PSCell, and the second configuration is for a conditional PSCell change/addition to the second PSCell; and means for providing, to the first base station, second information indicating that the first configuration is associated with the first identity, and the second configuration is associated with the second identity.

In an example, the means for determining associations comprises: means for receiving, from the first base station, a unique identity for each of the first and second configurations; and means for providing, to the first base station, a mapping between the unique identities and the first and second identities for conditional reconfigurations.

In an example, the apparatus comprises: means for providing, to the first base station, the first and second identities for first and second conditional reconfigurations; and means for receiving, from the first base station, a mapping between the first and second identities and unique identities.

In an example, the identities for conditional reconfigurations are secondary cell group identities, wherein the apparatus comprises: means for receiving, from the first base station, the first configuration with an associated first secondary cell group identity, and the second configuration with an associated second secondary cell group identity.

In an example, the apparatus comprises: means for receiving, from the first base station, information about a PSCell that the user equipment has connected to.

In an example, the information about the PSCell is received in a handover success message.

In an example, one of: the apparatus is for a second base station, the apparatus is comprised in the second base station, and the apparatus is the second base station.

In an example, the second base station is configured as a source master node.

According to an example, there is provided an apparatus for a user equipment, wherein the user equipment is connected to a source master node and a source secondary node, the apparatus comprising: means for receiving, from a second base station, a first configuration for a first conditional procedure and a second configuration for a second conditional procedure; means for receiving, from the second base station, a first identity and a second identity for conditional reconfigurations associated with respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; means for selecting a configuration from the received first and second configurations; and means for providing, to the first base station, information related to an identity for a conditional reconfiguration for the selected configuration.

In an example, each of the first and second configurations comprises a configuration for: a conditional handover, and at least two conditional PSCell change/additions.

In an example, the means for providing comprises: means for generating a radio resource control reconfiguration complete message; and means for providing the radio resource control reconfiguration complete message comprising the information related to an identity for a conditional reconfiguration for the selected configuration.

In an example, the information comprises one of: an identity for a conditional reconfiguration, and a secondary cell group identity.

In an example, one of: the apparatus is for the user equipment, the apparatus is comprised in the user equipment, and the apparatus is the user equipment.

According to an aspect, there is provided a method performed by a first base station configured as a target master node comprising: determining: configurations for at least two conditional procedures for a user equipment connected to a source master node and a source secondary node; determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; receiving, from the user equipment, information about a selected identity for conditional reconfiguration; and determining, based on the received information, a PSCell that the user equipment has connected to.

In an example, the determining the PSCell comprises: determining, based on the received information and the associations, a PSCell that the user equipment has connected to.

In an example, each of the first and second configurations comprises a configuration for: a conditional handover, and at least two conditional PSCell change/additions.

In an example, the determining a first identity and a second identity for conditional reconfigurations associated with, or to be associated with, respective first and second conditional procedures comprises: receiving, from a second base station, provisional identities for conditional reconfigurations for PSCells; and providing, to the second base station, the first configuration with the associated first identity, and the second configuration with the associated second identity.

In an example, the determining a first identity and a second identity for conditional reconfigurations associated with, or to be associated with, respective first and second conditional procedures comprises: providing, to a second base station, first information indicating that: the first configuration is for a conditional PSCell change/addition to the first PSCell, and the second configuration is for a conditional PSCell change/addition to the second PSCell; and receiving, from the second base station, second information indicating that the first configuration is associated with the first identity, and the second configuration is associated with the second identity.

In an example, the determining associations comprises: providing, to a second base station, a unique identity for each of the first and second configurations; and receiving, from the second base station, a mapping between the unique identities and the first and second identities for conditional reconfigurations.

In an example, the determining associations: receiving, from a second base station, the first and second identities for conditional reconfigurations; determining a mapping between the first and second identities for conditional reconfigurations and unique identities; and providing the mapping to the second base station.

In an example, the determining the PSCell comprises: determining, based on the mapping and the received information, the PSCell that the user equipment has connected to.

In an example, the identities for conditional reconfigurations are secondary cell group identities, wherein the determining a first identity and a second identity for conditional reconfigurations associated with, or to be associated with, respective first and second conditional procedures comprises: assigning a secondary cell group identity for each of the first and second configurations; providing, to a second base station, the first configuration with an associated first secondary cell group identity, and the second configuration with an associated second secondary cell group identity.

In an example, the information about the selected identity is received in a radio resource control reconfiguration complete message from the user equipment.

In an example, the method comprises at least one of: based on the determined PSCell that the user equipment has connected to, initiating a release procedure towards at least one target secondary node; based on the determined PSCell that the user equipment has connected to, providing data forwarding to at least one target secondary node associated with the executed configuration; based on the determined PSCell that the user equipment has connected to, activating at least one data bearers that is associated with the executed configuration.

In an example, the method comprises: in response to receiving a radio resource control reconfiguration complete message without information about a selected identity for a conditional reconfiguration from the user equipment, initiating a release procedure towards all target secondary nodes associated with the configurations for the at least two conditional procedures.

In an example, the method comprises: determining information about the PSCell that the user equipment has connected to; and providing, to the second base station, the information about the PSCell.

In an example, the information about the PSCell is provided in a handover success message.

According to an aspect, there is provided a method performed by a second base station configured as a source master node comprising: determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; providing, to one of: a user equipment and a first base station, information related to the determined first identity and second identity for conditional reconfigurations associated with, or to be associated with, respective first and second conditional procedures; and providing, to the user equipment, the first configuration for the first conditional procedure and the second configuration for the second conditional procedure.

In an example, each of the first and second configurations comprises a configuration for: a conditional handover, and at least two conditional PSCell change/additions.

In an example, the determining a first identity and a second identity for conditional reconfigurations associated with, or to be associated with, respective first and second conditional procedures comprises: providing, to the first base station, provisional identities for conditional reconfigurations for PSCells; and receiving, from the first base station, the first configuration with the associated first identity, and the second configuration with the associated second identity.

In an example, the determining a first identity and a second identity for conditional reconfigurations associated with, or to be associated with, respective first and second conditional procedures comprises: receiving, from the first base station, first information indicating that: the first configuration is for a conditional PSCell change/addition to the first PSCell, and the second configuration is for a conditional PSCell change/addition to the second PSCell; and providing, to the first base station, second information indicating that the first configuration is associated with the first identity, and the second configuration is associated with the second identity.

In an example, the determining associations comprises: receiving, from the first base station, a unique identity for each of the first and second configurations; and providing, to the first base station, a mapping between the unique identities and the first and second identities for conditional reconfigurations.

In an example, the method comprises: providing, to the first base station, the first and second identities for first and second conditional reconfigurations; and receiving, from the first base station, a mapping between the first and second identities and unique identities.

In an example, the identities for conditional reconfigurations are secondary cell group identities, wherein the apparatus comprises: receiving, from the first base station, the first configuration with an associated first secondary cell group identity, and the second configuration with an associated second secondary cell group identity.

In an example, the method comprises: receiving, from the first base station, information about a PSCell that the user equipment has connected to.

In an example, the information about the PSCell is received in a handover success message.

According to an aspect, there is provided a method performed by a user equipment comprising: receiving, from a second base station, a first configuration for a first conditional procedure and a second configuration for a second conditional procedure; receiving, from the second base station, a first identity and a second identity for conditional reconfigurations associated with respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; selecting a configuration from the received first and second configurations; and providing, to the first base station, information related to an identity for a conditional reconfiguration for the selected configuration.

In an example, each of the first and second configurations comprises a configuration for: a conditional handover, and at least two conditional PSCell change/additions.

In an example, the providing comprises: generating a radio resource control reconfiguration complete message; and providing the radio resource control reconfiguration complete message comprising the information related to an identity for a conditional reconfiguration for the selected configuration.

In an example, the information comprises one of: an identity for a conditional reconfiguration, and a secondary cell group identity.

According to an aspect, there is provided an apparatus comprising: at least one processor, and at least one memory storing instructions that, when executed by the at least one processor, cause the apparatus to perform: determining: configurations for at least two conditional procedures for a user equipment connected to a source master node and a source secondary node; determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; receiving, from the user equipment, information about a selected identity for conditional reconfiguration; and determining, based on the received information, a PSCell that the user equipment has connected to.

In an example, the determining the PSCell comprises: determining, based on the received information and the associations, a PSCell that the user equipment has connected to.

In an example, each of the first and second configurations comprises a configuration for: a conditional handover, and at least two conditional PSCell change/additions.

In an example, the determining a first identity and a second identity for conditional reconfigurations associated with, or to be associated with, respective first and second conditional procedures comprises: receiving, from a second base station, provisional identities for conditional reconfigurations for PSCells; and providing, to the second base station, the first configuration with the associated first identity, and the second configuration with the associated second identity.

In an example, the determining a first identity and a second identity for conditional reconfigurations associated with, or to be associated with, respective first and second conditional procedures comprises: providing, to a second base station, first information indicating that: the first configuration is for a conditional PSCell change/addition to the first PSCell, and the second configuration is for a conditional PSCell change/addition to the second PSCell; and receiving, from the second base station, second information indicating that the first configuration is associated with the first identity, and the second configuration is associated with the second identity.

In an example, the determining associations comprises: providing, to a second base station, a unique identity for each of the first and second configurations; and receiving, from the second base station, a mapping between the unique identities and the first and second identities for conditional reconfigurations.

In an example, the determining associations: receiving, from a second base station, the first and second identities for conditional reconfigurations; determining a mapping between the first and second identities for conditional reconfigurations and unique identities; and providing the mapping to the second base station.

In an example, the determining the PSCell comprises: determining, based on the mapping and the received information, the PSCell that the user equipment has connected to. In an example, the identities for conditional reconfigurations are secondary cell group identities, wherein the determining a first identity and a second identity for conditional reconfigurations associated with, or to be associated with, respective first and second conditional procedures comprises: assigning a secondary cell group identity for each of the first and second configurations; providing, to a second base station, the first configuration with an associated first secondary cell group identity, and the second configuration with an associated second secondary cell group identity.

In an example, the information about the selected identity is received in a radio resource control reconfiguration complete message from the user equipment.

In an example, the apparatus is caused to perform at least one of: based on the determined PSCell that the user equipment has connected to, initiating a release procedure towards at least one target secondary node; based on the determined PSCell that the user equipment has connected to, providing data forwarding to at least one target secondary node associated with the executed configuration; based on the determined PSCell that the user equipment has connected to, activating at least one data bearers that is associated with the executed configuration.

In an example, the method co the apparatus is caused to perform mprises: in response to receiving a radio resource control reconfiguration complete message without information about a selected identity for a conditional reconfiguration from the user equipment, initiating a release procedure towards all target secondary nodes associated with the configurations for the at least two conditional procedures.

In an example, the apparatus is caused to perform: determining information about the PSCell that the user equipment has connected to; and providing, to the second base station, the information about the PSCell.

In an example, the information about the PSCell is provided in a handover success message.

According to an aspect, there is provided an apparatus comprising: at least one processor, and at least one memory storing instructions that, when executed by the at least one processor, cause the apparatus to perform: determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; providing, to one of: a user equipment and a first base station, information related to the determined first identity and second identity for conditional reconfigurations associated with, or to be associated with, respective first and second conditional procedures; and providing, to the user equipment, the first configuration for the first conditional procedure and the second configuration for the second conditional procedure.

In an example, each of the first and second configurations comprises a configuration for: a conditional handover, and at least two conditional PSCell change/additions.

In an example, the determining a first identity and a second identity for conditional reconfigurations associated with, or to be associated with, respective first and second conditional procedures comprises: providing, to the first base station, provisional identities for conditional reconfigurations for PSCells; and receiving, from the first base station, the first configuration with the associated first identity, and the second configuration with the associated second identity.

In an example, the determining a first identity and a second identity for conditional reconfigurations associated with, or to be associated with, respective first and second conditional procedures comprises: receiving, from the first base station, first information indicating that: the first configuration is for a conditional PSCell change/addition to the first PSCell, and the second configuration is for a conditional PSCell change/addition to the second PSCell; and providing, to the first base station, second information indicating that the first configuration is associated with the first identity, and the second configuration is associated with the second identity.

In an example, the determining associations comprises: receiving, from the first base station, a unique identity for each of the first and second configurations; and providing, to the first base station, a mapping between the unique identities and the first and second identities for conditional reconfigurations.

In an example, the apparatus is caused to perform: providing, to the first base station, the first and second identities for first and second conditional reconfigurations; and receiving, from the first base station, a mapping between the first and second identities and unique identities.

In an example, the identities for conditional reconfigurations are secondary cell group identities, wherein the apparatus comprises: receiving, from the first base station, the first configuration with an associated first secondary cell group identity, and the second configuration with an associated second secondary cell group identity.

In an example, the apparatus is caused to perform: receiving, from the first base station, information about a PSCell that the user equipment has connected to.

In an example, the information about the PSCell is received in a handover success message.

According to an aspect, there is provided an apparatus comprising: at least one processor, and at least one memory storing instructions that, when executed by the at least one processor, cause the apparatus to perform: receiving, from a second base station, a first configuration for a first conditional procedure and a second configuration for a second conditional procedure; receiving, from the second base station, a first identity and a second identity for conditional reconfigurations associated with respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; selecting a configuration from the received first and second configurations; and providing, to the first base station, information related to an identity for a conditional reconfiguration for the selected configuration.

In an example, each of the first and second configurations comprises a configuration for: a conditional handover, and at least two conditional PSCell change/additions.

In an example, the providing comprises: generating a radio resource control reconfiguration complete message; and providing the radio resource control reconfiguration complete message comprising the information related to an identity for a conditional reconfiguration for the selected configuration.

In an example, the information comprises one of: an identity for a conditional reconfiguration, and a secondary cell group identity.

According to an aspect, there is provided a computer program comprising instructions, which when executed by an apparatus, cause the apparatus to perform at least the following: determining: configurations for at least two conditional procedures for a user equipment connected to a source master node and a source secondary node; determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; receiving, from the user equipment, information about a selected identity for conditional reconfiguration; and determining, based on the received information, a PSCell that the user equipment has connected to.

According to an aspect, there is provided a computer program comprising instructions, which when executed by an apparatus, cause the apparatus to perform at least the following: determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; providing, to one of: a user equipment and a first base station, information related to the determined first identity and second identity for conditional reconfigurations associated with, or to be associated with, respective first and second conditional procedures; and providing, to the user equipment, the first configuration for the first conditional procedure and the second configuration for the second conditional procedure.

According to an aspect, there is provided a computer program comprising instructions, which when executed by an apparatus, cause the apparatus to perform at least the following: receiving, from a second base station, a first configuration for a first conditional procedure and a second configuration for a second conditional procedure; receiving, from the second base station, a first identity and a second identity for conditional reconfigurations associated with respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; selecting a configuration from the received first and second configurations; and providing, to the first base station, information related to an identity for a conditional reconfiguration for the selected configuration.

According to an aspect, there is provided a non-transitory computer readable medium comprising program instructions, that, when executed by an apparatus, cause the apparatus to perform: determining: configurations for at least two conditional procedures for a user equipment connected to a source master node and a source secondary node; determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; receiving, from the user equipment, information about a selected identity for conditional reconfiguration; and determining, based on the received information, a PSCell that the user equipment has connected to.

According to an aspect, there is provided a non-transitory computer readable medium comprising program instructions, that, when executed by an apparatus, cause the apparatus to perform: determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; providing, to one of: a user equipment and a first base station, information related to the determined first identity and second identity for conditional reconfigurations associated with, or to be associated with, respective first and second conditional procedures; and providing, to the user equipment, the first configuration for the first conditional procedure and the second configuration for the second conditional procedure.

According to an aspect, there is provided a non-transitory computer readable medium comprising program instructions, that, when executed by an apparatus, cause the apparatus to perform: receiving, from a second base station, a first configuration for a first conditional procedure and a second configuration for a second conditional procedure; receiving, from the second base station, a first identity and a second identity for conditional reconfigurations associated with respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; selecting a configuration from the received first and second configurations; and providing, to the first base station, information related to an identity for a conditional reconfiguration for the selected configuration.

According to an aspect, there is provided an apparatus comprising: circuitry configured to perform determining: configurations for at least two conditional procedures for a user equipment connected to a source master node and a source secondary node; circuitry configured to perform determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells; circuitry configured to perform receiving, from the user equipment, information about a selected identity for conditional reconfiguration; and circuitry configured to perform determining, based on the received information, a PSCell that the user equipment has connected to.

A computer product stored on a medium may cause an apparatus to perform the methods as described herein.

A non-transitory computer readable medium comprising program instructions, that, when executed by an apparatus, cause the apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### LIST OF ABBREVIATIONS

AF: Application Function
AMF: Access and Mobility Management Function
AN: Access Network
BS: Base Station
CHO: Conditional handover
CN: Core Network
CPAC: Conditional PSCell addition/change
DL: Downlink
eNB: eNodeB
gNB: gNodeB
IIoT: Industrial Internet of Things
LTE: Long Term Evolution
NEF: Network Exposure Function
NG-RAN: Next Generation Radio Access Network
NF: Network Function
NR: New Radio
NRF: Network Repository Function
NW: Network
MN: Master node
MCG: Master cell group
MS: Mobile Station
PCell: Primary cell
PSCell: Primary SCG cell
PCF Policy Control Function
PLMN: Public Land Mobile Network
RAN: Radio Access Network
RF: Radio Frequency
SN: Secondary node
SCG: Secondary cell group
SMF: Session Management Function
S-MN: Source-master node
S-SN: Source-secondary node
T-MN: Target-master node
T-SN: Target-secondary node
UE: User Equipment
UDR: Unified Data Repository
UDM: Unified Data Management
UL: Uplink
UPF: User Plane Function
3GPP: 3rd Generation Partnership Project
5G: 5th Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation a wireless communication system with dual connectivity;

FIG. 3 shows an example of signalling between a user equipment and network entities;

FIG. 4 shows another example of signalling between a user equipment and network entities;

FIG. 5 shows another example of signalling between a user equipment and network entities;

FIG. 6 shows another example of signalling between a user equipment and network entities;

FIG. 7 shows another example of signalling between a user equipment and network entities;

FIG. 8 shows another example of signalling between a user equipment and network entities;

FIG. 9 shows another example of signalling between a user equipment and network entities;

FIG. 10 shows a schematic representation of a control apparatus according to some example embodiments;

FIG. 11 shows a schematic representation of a terminal apparatus according to some example embodiments;

FIG. 12 shows an example method flow performed by an apparatus;

FIG. 13 shows another example method flow performed by an apparatus;

FIG. 14 shows another example method flow performed by an apparatus; and

FIG. 15 shows a schematic representation of a non-volatile memory medium storing instructions which when executed by a processor allow a processor to perform one or more of the steps of the methods of some embodiments.

### DETAILED DESCRIPTION

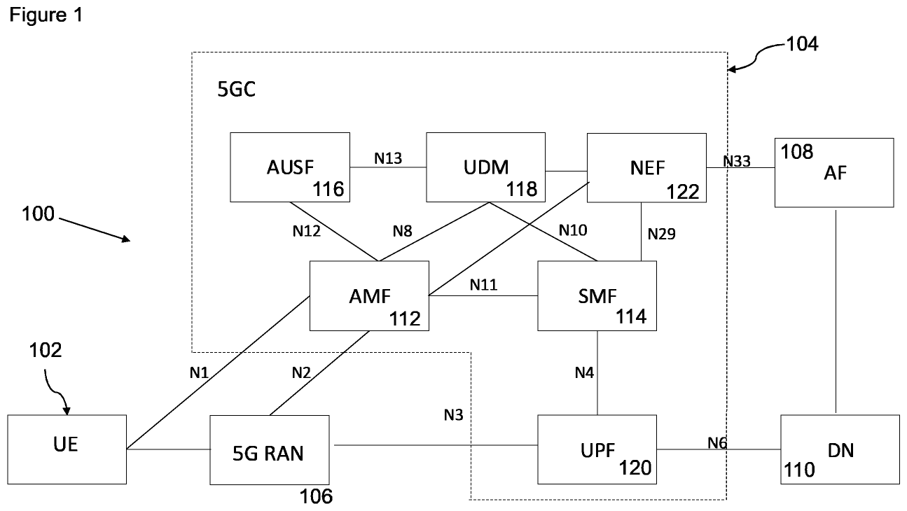

In the following, certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of the disclosure, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a wireless communication system 100. The wireless communication system 100 may comprise one more devices 102 such as user equipments (UEs), or terminals. The wireless communication system 100 may also comprise a 5G system (5GS), as shown in Figure. The 5GS comprises a 5G radio access network (5G-RAN) 106, a 5G core network (5GC) 104 comprising one or more network functions (NF), one or more application functions (AFs) 108, and one or more data networks (DNS) 110.

The 5G-RAN 106 may comprise one or more gNodeB (gNB) distributed unit (DU) functions connected to one or more gNodeB (gNB) centralized unit (CU) functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 5G-advanced, 4G, 3G and other 3GPP standards.

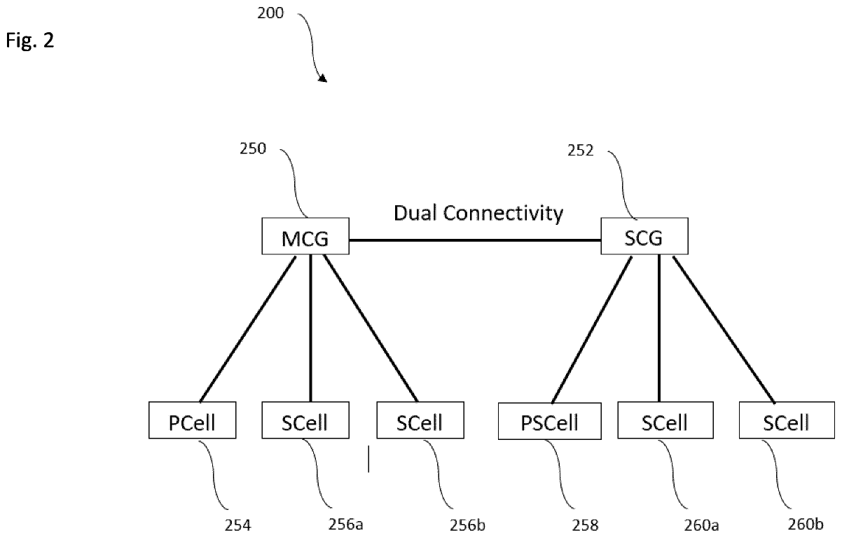

In a wireless communication system 100, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a base station or access point, and transmit and/or receive communications on the carrier. FIG. 2 shows a schematic representation a wireless communication system with dual connectivity. There is provided a system 200 in which some examples may be performed. System 200 comprises Master Cell Group (MCG) 250 and a Secondary Cell Group (SCG) 252. System 200 may also comprise other SCGs, each having a primary SCG cell (PSCell). Each of the of other SCGs may also have one or more secondary cells (SCells).

MCG 250 comprises a Primary Cell (PCell) 254. PCell 254 may be used to initiate initial access for a UE. MCG 250 may also comprise other cells comprising at least one Secondary Cell (SCell) 256a and 256b.

MCG 250 may be controlled by a Master Node (MN).

MCG 250 is connected to SCG 252 by a Dual Connectivity (DC) system. SCG 252 comprises a Primary Secondary Cell (PSCell) 258 which may be used as a cell for which initial access is initiated for SCG 252. SCG 252 may also comprise other cells comprising at least one Secondary Cell (SCell) 260a and 260b.

SCG 252 may be controlled by a Secondary Node (SN). Each SCG in system 200 may comprise a SN.

In examples, the following information may provide further details of alternatives, modifications and variances for systems associated with the following examples. A gNB comprises e.g., a node providing NR user plane and control plane protocol terminations towards the UE, and connected via the NG interface to the 5GC, e.g., according to 3GPP TS 38.300 V16.6.0 (2021-06) section 3.2.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU.

The gNB-D U terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1.

Different functional splits between the central and distributed unit are possible, e.g., called options: Option 1 (1A-like split):—The function split in this option is similar to the 1A architecture in DC. RRC is in the central unit. PDCP, RLC, MAC, physical layer and RF are in the distributed unit. Option 2 (3C-like split):—The function split in this option is similar to the 3C architecture in DC. RRC and PDCP are in the central unit. RLC, MAC, physical layer and RF are in the distributed unit. Option 3 (intra RLC split):—Low RLC (partial function of RLC), MAC, physical layer and RF are in the distributed unit. PDCP and high RLC (the other partial function of RLC) are in the central unit. Option 4 (RLC-MAC split):—MAC, physical layer and RF are in the distributed unit. PDCP and RLC are in the central unit. Or else, e.g., according to 3GPP TR 38.801 V14.0.0 (2017-03) section 11.

A gNB supports different protocol layers, e.g., Layer 1 (L1)—physical layer. The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.: The physical layer offers to the MAC sublayer transport channels; The MAC sublayer offers to the RLC sublayer logical channels; The RLC sublayer offers to the PDCP sublayer RLC channels; The PDCP sublayer offers to the SDAP sublayer radio bearers; The SDAP sublayer offers to 5GC QoS flows; Comp. refers to header compression and Segm. To segmentation; Control channels include (BCCH, PCCH).

Layer 3 (L3) includes e.g., Radio Resource Control (RRC), e.g., according to 3GPP TS 38.300 V16.6.0 (2021-06) section 6.

A RAN (Radio Access Network) node or access node or network node like e.g. a gNB, base station, gNB CU or gNB DU or parts thereof may be configured to support master node functionalities and/or secondary node functionalities and may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4,).

A UE is e.g., either in RRC_CONNECTED state or in RRC_INACTIVE state when an RRC connection has been established.

In RRC_CONNECTED state a UE may: store the AS context; transfer unicast data to/from the UE; monitor control channels associated with the shared data channel to determine if data is scheduled for the data channel; provide channel quality and feedback information; perform neighbouring cell measurements and measurement reporting. The RRC protocol includes e.g. the following main functions: RRC connection control; measurement configuration and reporting; establishment/modification/release of measurement configuration (e.g. intra-frequency, inter-frequency and inter-RAT measurements); setup and release of measurement gaps; measurement reporting.

A UE can be in dual connectivity with a MN (wherein the MN may comprise a PCell) and a SN (wherein the SN may comprise a PSCell). Therefore, a UE in dual connectivity with a MN and SN may be configured with a corresponding PCell and PSCell. The MN or SN can initiate a Conditional Primary Secondary Cell Change (CPC) procedure.

3GPP Release 17 describes conditional handover (CHO) in MR-DC limited to the scenario where a target MN can prepare a single target PSCell, under the control of an SN. However, this limits the usefulness of the CHO MR-DC feature in a situation where a UE may need to access different/other target PSCells when the CHO needs to be executed.

Objective 4 of the work item description (WID) of Further NR mobility enhancements addresses CHO and conditional PSCell Addition (CPA)/conditional PSCell change (CPC). It is noted that CPA and CPC may be referred to asCPAC. This objective provides a configuration to a UE which consists of both CHO and CPAC configurations. For example, a UE may conditionally handover to both a Pcell and PSCell, considering the execution conditions of each cell given in the handover configuration. 3GPP Release 17 provides that when a UE executes a CPA or inter-SN CPC configuration, the UE sends a RRCReconfigurationComplete message to a source MN (S-MN). The RRCReconfigurationComplete message may be used to confirm the successful completion of an RRC connection reconfiguration. In the case that the executed conditional reconfiguration is CPA or inter-SN CPC configured by a S-MN, the UE includes a CondReconfigld for the selected cell of conditional reconfiguration execution. Therefore, the S-MN can understand which candidate T-SN PSCell the UE has accessed/selected. The S-MN may notify other T-SNs, which were prepared for CPAC but in which the PSCells of these T-SNs were not selected as a candidate PSCells for CPAC, to release the preparation. The S-MN may handle data forwarding towards the T-SN of the candidate PSCell of which the UE has executed the CPAC configuration.

3GPP Release 18 describes that when the S-MN sends a CHO request to a T-MN, the T-MN can prepare multiple T-SNs with a CPAC configuration for a dual connectivity handover. For example, the T-MN may prepare multiple PSCells for the same PCell such that the UE has access to both the T-MN's PCell and the T-SNs PSCells if the execution conditions for both CHO and CPAC are met. It is also possible that the T-MN provides a pure CHO configuration for a single connectivity handover, along with CHO+CPAC configurations. When the UE executes one of the configurations provided by the T-MN, the T-MN may not know which configuration the UE has applied. For example, the T-MN may not know whether the UE has applied a CHO configuration or a CHO+CPAC configuration, and if the UE has applied a CHO+CPAC configuration, the T-SN may not know which CHO+CPAC configuration the UE has applied. There may be one ID assigned by the S-MN for each configuration. For example, if the UE is configured with three configurations, each configuration will have one ID. For example, the UE may be configured with a CHO configuration (i.e., for a single connectivity handover) comprising a CondReconfigID-1 for a prepared PCell-1, a CHO+CPAC configuration (i.e., for a dual connectivity handover) with CondReconfigID-2 for prepared PCell-1 and PSCell-1, and CHO+CPAC configuration (i.e., for a dual connectivity handover) with CondReconfigID-3 for prepared PCell-1 and PSCell-2.

However, in 3GPP Release 18, the CondReconfigID related to the CHO is not reported to the T-MN. This is because the T-MN can determine the target PCell which is selected by the UE from the random access procedure to one of the prepared target PCells under the same target gNB. The ID is only known to the S-MN as the CondReconfigIDs are assigned by the S-MN, therefore on execution of the CHO and/or CHO+CPAC configuration, the T-MN does not know which configuration the UE has executed. As such, the T-MN may not be able to identify the selected CPAC when the UE executes CHO and sends the RRCReconfigurationComplete message. This means that the T-MN may not be able to: decide which CPAC needs to be released; handle data forwarding towards selected T-SN properly; setup the proper bearers that correspond to executed CPAC.

R2-2300095 proposes a UE which can indicate the Physical Cell ID (PCI) and/or frequency of the selected target PSCell to the target MN. To indicate the frequency and the PCI, the UE needs to send in total 32 bits (22 bits for frequency and 10 bits for PCI). However, adding 32 bits to a RRCReconfigurationComplete message may impact the size of the UL grant that is provided by the target cell in RACH Response (RAR) for sending the complete message.

3GPP Release 18 describes that in a scenario involving CHO with dual connectivity (DC) at the target side, in response to a handover (HO) request, the T-MN may prepare multiple PSCells for each PCell. For example, PCell1-PSCell 1; PCell1-PSCell2; PCell1-PSCell3, where each preparation corresponds to CHO and CPAC. The data forwarding configuration for each PCell-PSCell pair may be unique as different PSCells can be controlled by different SNs or can have different bearer re-mapping. In CHO with DC, the target MN may retain the source SN or may change the SN. When SN is changed, upon successful access to the target PCell/PSCell, the source MN is expected to include data forwarding address information of the selected PCell-PSCell pair in a Xn-U Address Indication. This is to be used by the source SN for either starting data forwarding of SCG bearers when late data forwarding is enabled or stopping data forwarding to other prepared SNs if early data forwarding is enabled. In CHO with DC, the source MN may need the direct data forwarding address for the target SN in order to initiate the data forwarding to target SN.

On successful evaluation of CPC and CHO execution conditions, and successful access to the target PCell, the UE can include the selected PCell information in the RRCReconfigurationComplete message sent to the target MN. As the HO success message to the source MN only includes the cell ID of a PCell, the source MN is not aware of which PSCell the UE has accessed. Therefore, there is an ambiguity at the source MN to identify the correct Tunnel Endpoint Identifier (TEID) related to the PCell-PSCell pair that the UE has applied. The ambiguity may disable data forwarding altogether. Further, in Career Aggregation (CA) scenarios, the UE might have different CA configurations, i.e., SCells along PSCell or PCell. Determination of whether the SCell is activated along the PCell or along the PSCell would require data related to the SCell to be forwarded to the right network node.

TS 37.340 describes that the source MN sends an XN-U Address Indication message to the source SN to transfer data forwarding information. More than one data forwarding addresses may be provided if the PDU session is split in the target side. If the execution condition of one candidate PSCell is satisfied, the UE applies an RRCReconfiguration message corresponding to the selected candidate PSCell, sends an MN RRCReconfigurationComplete message, including an NR RRCReconfigurationComplete message for the selected candidate PSCell, and sends information enabling the MN to identify the SN of the selected candidate PSCell. In existing schemes, the HO Success message contains the Global Cell ID of the PCell selected by the UE, which is used by the source MN to fetch the TEID related to the Global Cell ID. However, this is not sufficient when the target MN prepares a CHO configuration for multiple PSCells for each PCell.

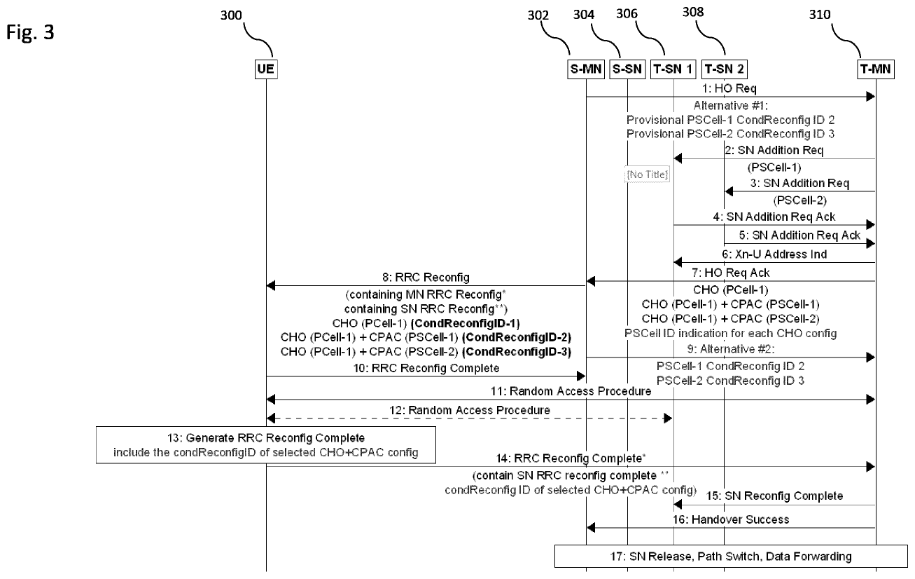

Some examples described herein aim to address one or more of the problems discussed above by introducing a mechanism for enabling a T-MN to be aware of the CHO and/or CHO+CPAC configuration that the UE has executed. These examples will be described in more detail below alongside FIGS. 3 to 6.

FIG. 3 shows an example of signalling between a user equipment and network entities.

In this example, an S-MN 302 informs a T-MN 310 about condReconfigIDs that are assigned by the S-MN 302, and their associations with PSCell IDs. Then, a UE 300 informs the T-MN 310 about the selected condReconfigID. Hence, this enables the T-MN 310 to understand which CPAC configuration the UE has executed. This will be described in more detail below.

At S1, the S-MN 302 sends a HO Request to the T-MN 310. In some examples, the S-MN 302 includes the provisional condReconfigIDs for potential CPAC candidate cells in the HO Request. For example, the S-MN 302 may include condReconfigID 2 and/or condReconfigID 3 in the HO Request. In some examples, condReconfigID 2 may be assigned to the CHO configuration if the CHO configuration is associated with a PSCell-1 CPAC configuration and condReconfigID 3 may be assigned to the CHO configuration if the CHO configuration is associated with a PSCell-2 CPAC configuration. In some examples, including the provisional condReconfigIDs for potential CPAC candidate cells in the HO Request may be an alternative to the embodiments of S9 (described below).

At S2 and S3, the T-MN 310 prepares at least one PSCell and transmits the at least one PSCell to at least one T-SN 306, 308 in a SN Addition Request. In some examples, the T-MN 310 prepares PSCell-1 and transmits this to T-SN 1 306 in a SN Addition Request for CPAC and/or the T-MN 310 prepares PSCell-2 and transmits this to T-SN 2 308 in a SN Addition Request for CPAC. In some examples, CPAC may be configured along with the CHO configurations of the T-MN 310.

At S4 and S5, the at least one T-SN 306, 308 transmits a SN Addition Request Ack message to the T-MN 310.

At S6, the T-MN 310 transmits a Xn-U Address Indication message to at least one T-SN 306, 308.

At S7, the T-MN 310 transmits a HO Request Ack message to the S-MN 302. In some examples, the T-MN 310 generates 3 configurations and sends them to the S-MN 302 in the HO Request Ack message. In some examples, the configurations may be one or more of: Config 1; Config 2; Config3. In some examples, Config 1 comprises a CHO configuration (i.e., Config 1 may be for a single connectivity handover and may comprise PCell-1 but no CPAC or PSCell). In some examples, Config 2 comprises a CHO configuration of PCell 1 and a CPAC configuration of PSCell 1 (i.e., Config 2 may be for a dual connectivity handover). In some examples, Config 3 comprises a CHO configuration of PCell 1 and a CPAC configuration of PSCell 2 (i.e., Config 3 may be for a dual connectivity handover). In some examples, the CHO configurations in each configuration can be the same or different. In some examples, whether the CHO configurations in each configuration are the same or different depends on T-MN implementation. In some examples, if the CHO configuration includes a CPAC configuration, the T-MN 310 indicates, to the S-MN 302, the PSCell IDs and their operating frequencies for each CHO configuration. In some examples, if the PSCell IDs are not indicated, this indicates that the CHO configuration does not include a CPAC configuration.

At S8, the S-MN 302 generates a RRC Reconfiguration and transmits a RRC Reconfiguration message to the UE 300. In some examples, the S-MN 302 assigns its own condReconfigID for each CHO configuration. For example, the S-MN 302 may assign CondReconfig ID 1 for Config 1, CondReconfig ID 2 for Config 2 and/or CondReconfig ID 3 for Config 3.

At S9, in a case where the S-MN 302 does not include the provisional condReconfig IDs for potential CPAC candidate cells in the HO Request (i.e., as described as an example embodiment in S1), the S-MN 302 may send the condReconfigIDs associated with each CHO configuration (wherein each CHO configuration is associated with a PSCell CPAC configuration). For example, the S-MN 302 may transmit a message to the T-MN 310 comprising CondReconfigID 2 for a CHO configuration associated with a PSCell-1 CPAC configuration and/or CondReconfigID 3 for a CHO configuration associated with a PSCell-2 CPAC configuration.

At S10, the UE 300 sends a RRC Reconfiguration Complete message to the S-MN 302. In some examples, the RRC Reconfiguration Complete is to indicate that the RRC Reconfiguration in S8 has been successfully received.

At S11 and S12, once one of the CHO+CPAC conditions are met, the UE 300 performs a Random-Access Procedure. For example, if PCell-1 and one of the PSCell access conditions are met, the UE 300 handovers to PCell-1 and the PSCell of which the access conditions have been met.

At S13, the UE 300 generates the RRC Reconfiguration Complete message for the executed configuration (for example, either Config 1, Config 2 or Config 3). In some examples, the UE 300 generates an RRC Reconfiguration Complete message for the T-MN's RRC Reconfiguration Complete message (for CHO) and the SN's RRC Reconfiguration Complete message (for CPAC). In some examples, the SN RRC Reconfiguration Complete message will be included in the RRC Reconfiguration Complete message. In some examples, the RRC Reconfiguration Complete is for the executed CHO configuration and may be read by the T-MN 310. In some examples the SN RRC Reconfiguration Complete is for the executed CPAC configuration that may be read by the T-SN 306, 308. In some examples, if Config 2 or Config 3 is executed, the UE 300 will include the condReconfigID of the selected configuration. For example, if Config 2 is executed, the UE 300 may include the condReconfigID 2 in the RRC Reconfiguration Complete message. If Config 3 is executed, the UE 300 may include the condReconfigID 3 in the RRC Reconfiguration Complete message. In some examples, the selected condReconfigID is placed in the RRC Reconfiguration Complete message in a way such that when the T-MN 310 receives it, the T-MN 310 can read the information. For example, the selected condReconfigID is placed outside of, or separate from, the included SN RRC Reconfiguration Complete message. Said another way, the RRC Reconfiguration Complete message and the CondReconfigID is provided.

At S14, the UE 300 sends the RRC Reconfiguration Complete message to the T-MN 310 along with the SN RRC Reconfiguration Complete Message. In some examples, the UE 300 includes the condReconfigID of the selected configuration in RRC Reconfiguration Complete* message. In some examples, if the RRC Reconfiguration Complete* includes the condReconfigID, the T-MN 310 is able to understand that the selected configuration is for a dual connectivity handover. In some examples, the T-MN 310 may then use the information from S1 or S9 to associate the condReconfigID with the PSCell. In some examples, if the T-MN 310 can associate the condReconfigID with the PSCell, the T-MN 310 can: initiate a release procedure towards the T-SNs 308 associated with the unused CPAC configurations; handle proper data forwarding towards the T-SN 306 associated with the used CPAC configuration; activate data bearers that are associated with the executed configuration. In some examples, if the RRC Reconfiguration Complete message does not include the condReconfigID, the T-MN 310 is able to understand that the selected configuration is for a single connectivity handover. In this example, the T-MN 310 can initiate the release procedure towards all T-SNs 306, 308 that have prepared CPAC configurations.

At S15, the T-MN 310 transmits a SN Reconfiguration Complete message to the T-SN 306 associated with the selected configuration. For example, if the UE has executed config 2, i.e., CHO+CPAC for PSCell-1 where the PSCell-1 is associated with T-SN 1 306, the T-MN 310 sends the SN Reconfiguration Complete to T-SN 1 306.

At S16, the T-MN 310 transmits a Handover Success message to the S-MN 302. For example, the T-MN 310 informs the S-MN 302 about a successful completion of the handover procedure from S-MN 302 to T-MN 310.

At S17, SN Release, Path Switch and Data forwarding steps are performed.

In this way, FIG. 3 includes two different examples of how the T-MN is made aware identies associated with different configurations. In the first alternative, the S-MN provides the provisional CondReconfigIDs to T-MN for each candidate PSCells (S1). And then, the T-MN replies back with configurations and indicates which configuration is associated with which PSCell. Eventually, when the T-MN receives the CondReconfigID from the UE (S14), the T-MN understands which configuration is executed (and thus which PSCell the UE has connected to). In the second alternative, the T-MN indicates which configuration includes which PSCell. Then, the S-MN informs the T-MN which CondReconfigID is used for each config that includes indicated PSCells (S9). Hence, when the T-MN receives

CondReconfigID from the UE (S14), the T-MN understands which configuration is executed (and thus which PSCell the UE has connected to).

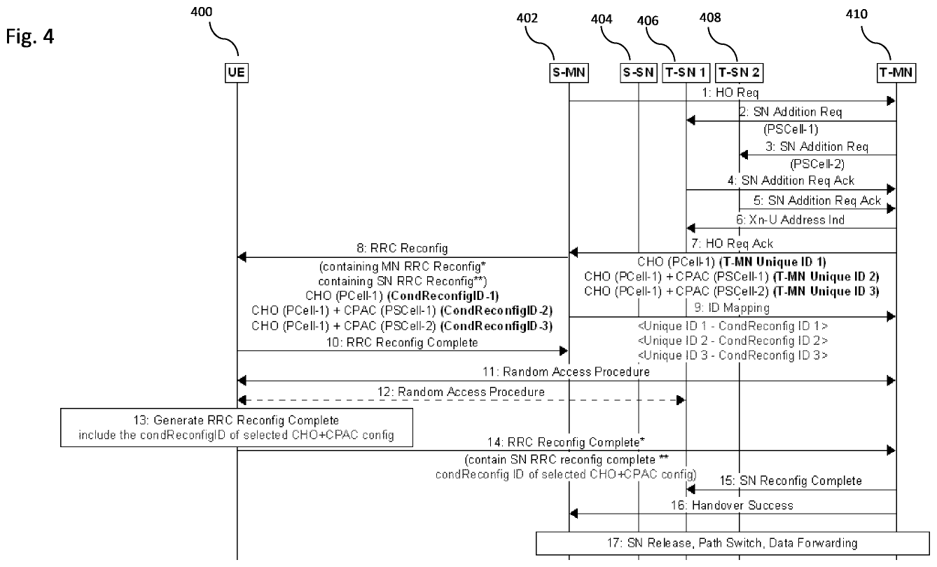

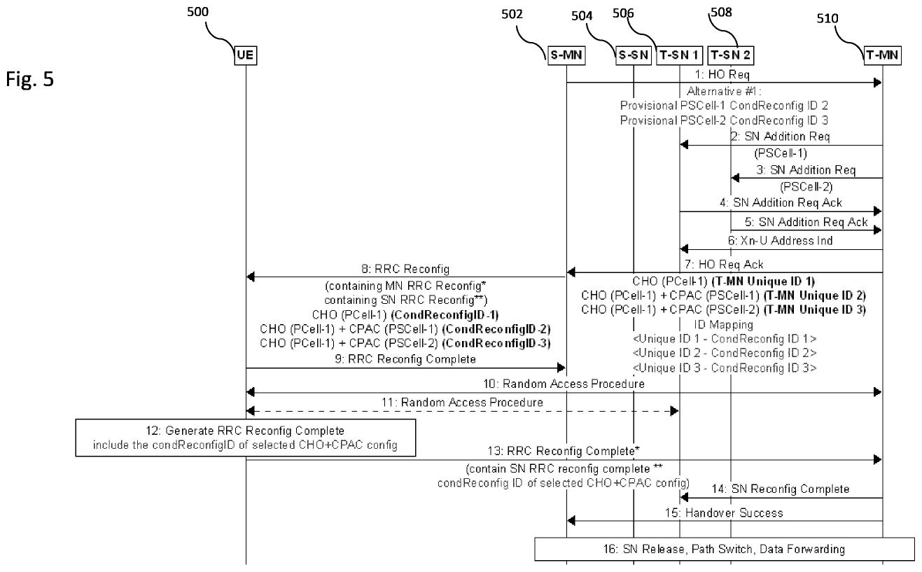

FIG. 4 shows another example of signalling between a user equipment and network entities. In this example, a T-MN 410 sends a unique ID to a S-MN 402 for each configuration along with the CHO or CHO+CPAC configurations. In some examples, the S-MN 402 may assign the condReconfigID for each configuration. The S-MN 402 may send, to the T-MN 410, the mapping of the condReconfigIDs and Unique IDs. In some examples, once the UE 400 sends the selected condReconfigID, the T-MN 410 may use the mapping information sent by the S-MN 402 to associate the condReconfigID with the selected CPAC configuration. This will be described in more detail below.

At S1, the S-MN 402 sends a HO Request to the T-MN 410.

At S2 and S3, the T-MN 410 prepares at least one PSCell and transmits the at least one PSCell to at least one T-SN 406, 408 in a SN Addition Request. In some examples, the T-MN 410 prepares PSCell-1 and transmits this to T-SN 1 406 in a SN Addition Request for CPAC and/or the T-MN 410 prepares PSCell-2 and transmits this to T-SN 2 408 in a SN

Addition Request for CPAC. In some examples, CPAC may be configured along with the CHO configurations of the T-MN 410.

At S4 and S5, the at least one T-SN 406, 408 transmits a SN Addition Request Ack message to the T-MN 410.

At S6, the T-MN 410 transmits a Xn-U Address Indication message to at least one T-SN 406, 408.

At S7, the T-MN 410 transmits a HO Request Ack message to the S-MN 402. In some examples, the T-MN 410 generates 3 configurations and sends them to the S-MN 402 in the HO Request Ack message. In some examples, the configurations may be one or more of: Config 1; Config 2; Config3. In some examples, Config 1 comprises a CHO configuration (i.e., Config 1 may be for a single connectivity handover and may comprise PCell-1 but no CPAC or PSCell). In some examples, Config 2 comprises a CHO configuration of PCell 1 and a CPAC configuration of PSCell 1 (i.e., Config 2 may be for a dual connectivity handover). In some examples, Config 3 comprises a CHO configuration of PCell 1 and a CPAC configuration of PSCell 2 (i.e., Config 3 may be for a dual connectivity handover). In some examples, the CHO configurations in each configuration can be the same or different. In some examples, whether the CHO configurations in each configuration are the same or different depends on T-MN implementation. In some examples, the T-MN 410 assigns a unique ID for each configuration that is sent to the S-MN 402. In some examples, the Unique IDs are used between the Xn interface, i.e., between S-MN 402 and T-MN 410, and are not included in the configurations (i.e., not sent to the UE 400).

At S8, the S-MN 402 generates a RRC Reconfiguration and transmits a RRC Reconfiguration message to the UE 400. In some examples, once the T-MN 410 provides the CHO configuration and CHO+CPAC configurations along with the Unique IDs to the S-MN 402, the S-MN 402 assigns the condReconfigIDs to those configurations and may keep the association in the S-MN 402 memory. In some examples, the S-MN 402 sends the configurations to the UE 400 with the S-MN's 402 assigned condReconfigIDs.

At S9, the S-MN 402 sends the mapping of the T-MN's 410 unique IDs and S-MN's 402 condReconfigIDs. For example, the S-MN 402 may transmit at least one of the following mappings: Unique ID 1-CondReconfigID 1; Unique ID 2-CondReconfigID 2; Unique ID 3-CondReconfigID 3.

At S10, the UE 400 sends a RRC Reconfiguration Complete message to the S-MN 402. In some examples, the RRC Reconfiguration Complete is to indicate that the RRC Reconfiguration in S8 has been successfully received.

At S11 and S12, once one of the CHO+CPAC conditions are met, the UE 400 performs a Random-Access Procedure. For example, if PCell-1 and one of the PSCell access conditions are met, the UE 400 handovers to PCell-1 and the PSCell of which the access conditions have been met.

At S13, the UE 400 generates the RRC Reconfiguration Complete message for the executed configuration (for example, either Config 1, Config 2 or Config 3). In some examples, the UE 400 generates an RRC Reconfiguration Complete message for the T-MN's RRC Reconfiguration Complete* message (for CHO) and the SN's RRC

Reconfiguration Complete message (for CPAC). In some examples, the SN RRC Reconfiguration Complete message will be included in the RRC Reconfiguration Complete message. In some examples, the RRC Reconfiguration Complete is for the executed CHO configuration and may be read by the T-MN 410. In some examples the SN RRC Reconfiguration Complete is for the executed CPAC configuration that may be read by the T-SN 406, 408. In some examples, if Config 2 or Config 3 is executed, the UE 400 will include the condReconfigID of the selected configuration. For example, if Config 2 is executed, the UE 400 may include the condReconfigID 2 in the RRC Reconfiguration Complete* message. If Config 3 is executed, the UE 400 may include the condReconfigID 3 in the RRC Reconfiguration Complete message. In some examples, the selected condReconfigID is placed in the RRC Reconfiguration Complete message in a way such that when the T-MN 410 receives it, the T-MN 410 can read the information.

At S14, the UE 400 sends the RRC Reconfiguration Complete message to the T-MN 410 along with the SN RRC Reconfiguration Complete Message. In some examples, once the T-MN 410 receives the condReconfigID from the UE 400, the T-MN 410 uses the mapping information from S9 and associates the condReconfigID with the relevant PSCell-ID.

At S15, the T-MN 410 transmits a SN Reconfiguration Complete message to the T-SN 406 associated with the selected configuration. For example, if the UE 400 has executed Config 2, i.e., CHO+CPAC for PSCell-1 where the PSCell-1 is associated with T-SN 1 406, the T-MN 410 sends the SN Reconfiguration Complete to T-SN 1 406.

At S16, the T-MN 410 transmits a Handover Success message to the S-MN 402. For example, the T-MN 410 informs the S-MN 402 about a successful completion of the handover procedure from S-MN 402 to T-MN 410.

At S17, SN Release, Path Switch and Data forwarding steps are performed.

FIG. 5 shows another example of signalling between a user equipment and network entities In this example, an S-MN 502 sends provisional condReconfigIDs to a T-MN 510 and the T-MN 510 responds with mapping between the condReconfigIDs and T-MN Unique IDs. This will be described in more detail below.

At S1, the S-MN 502 sends a HO Request to the T-MN 510. In some examples, the S-MN 502 includes the provisional condReconfigIDs for potential CPAC candidate cells in the HO Request. For example, the S-MN 502 may include condReconfigID 2 and/or condReconfigID 3 in the HO Request. In some examples, condReconfigID 2 may be assigned to the CHO configuration if the CHO configuration is associated with a PSCell-1 CPAC configuration and condReconfigID 3 may be assigned to the CHO configuration if the CHO configuration is associated with a PSCell-2 CPAC configuration.

At S2 and S3, the T-MN 510 prepares at least one PSCell and transmits the at least one PSCell to at least one T-SN 506, 508 in a SN Addition Request. In some examples, the T-MN 510 prepares PSCell-1 and transmits this to T-SN 1 506 in a SN Addition Request for CPAC and/or the T-MN 510 prepares PSCell-2 and transmits this to T-SN 2 508 in a SN Addition Request for CPAC. In some examples, CPAC may be configured along with the CHO configurations of the T-MN 510.

At S4 and S5, the at least one T-SN 506, 508 transmits a SN Addition Request Ack message to the T-MN 510.

At S6, the T-MN 510 transmits a Xn-U Address Indication message to at least one T-SN 506, 508.

At S7, the T-MN 510 transmits a HO Request Ack message to the S-MN 502. In some examples, the T-MN 510 generates 3 configurations and sends them to the S-MN 502 in the HO Request Ack message. In some examples, the configurations may be one or more of: Config 1; Config 2; Config3. In some examples, Config 1 comprises a CHO configuration (i.e., Config 1 may be for a single connectivity handover and may comprise PCell-1 but no CPAC or PSCell). In some examples, Config 2 comprises a CHO configuration of PCell 1 and a CPAC configuration of PSCell 1 (i.e., Config 2 may be for a dual connectivity handover). In some examples, Config 3 comprises a CHO configuration of PCell 1 and a CPAC configuration of PSCell 2 (i.e., Config 3 may be for a dual connectivity handover). In some examples, the CHO configurations in each configuration can be the same or different. In some examples, whether the CHO configurations in each configuration are the same or different depends on T-MN implementation. In some examples, the T-MN 510 assigns a unique ID for each configuration sent to the S-MN 502. These IDs are used between the Xn interface, i.e., between S-MN 502 and T-MN 510, and are not included in the configurations (i.e., not sent to the UE 500). In some examples, and in addition, the following mapping of the T-MN's unique IDs and S-MN's condReconfiglDs may be sent from the T-MN 510 to the S-MN 502: Unique ID 1-CondReconfigID 1; Unique ID 2-CondReconfigID 2; Unique ID 3-CondReconfigID 3.

At S8, the S-MN 502 generates a RRC Reconfiguration and transmits a RRC Reconfiguration message to the UE 500. In some examples, once the T-MN 510 provides the CHO configuration and CHO+CPAC configurations along with the Unique IDs to the S-MN 502, the S-MN 502 assigns the condReconfigIDs to those configurations and may keep the association in the S-MN 502 memory. In some examples, the S-MN 502 sends the configurations to the UE 500 with the S-MN's assigned condReconfigIDs.

At S9, the UE 500 sends a RRC Reconfiguration Complete message to the S-MN 502. In some examples, the RRC Reconfiguration Complete is to indicate that the RRC Reconfiguration in S8 has been successfully received.

At S10 and S11, once one of the CHO+CPAC conditions are met, the UE 500 performs a Random-Access Procedure. For example, if PCell-1 and one of the PSCell access conditions are met, the UE 500 handovers to PCell-1 and the PSCell of which the access conditions have been met.

At S12, the UE 500 generates the RRC Reconfiguration Complete message for the executed configuration (for example, either Config 1, Config 2 or Config 3). In some examples, the UE 500 generates an RRC Reconfiguration Complete message for the T-MN's RRC Reconfiguration Complete message (for CHO) and the SN's RRC Reconfiguration Complete message (for CPAC). In some examples, the SN RRC Reconfiguration Complete message will be included in the RRC Reconfiguration Complete message. In some examples, the RRC Reconfiguration Complete is for the executed CHO configuration and may be read by the T-MN 510. In some examples the SN RRC Reconfiguration Complete is for the executed CPAC configuration that may be read by the T-SN 506, 508. In some examples, if Config 2 or Config 3 is executed, the UE 500 will include the condReconfigID of the selected configuration. For example, if Config 2 is executed, the UE 500 may include the condReconfigID 2 in the RRC Reconfiguration Complete message. If Config 3 is executed, the UE 500 may include the condReconfigID 3 in the RRC Reconfiguration Complete message. In some examples, the selected condReconfigID is placed in the RRC Reconfiguration Complete message in a way such that when the T-MN 510 receives it, the T-MN 510 can read the information.

At S13, the UE 500 sends the RRC Reconfiguration Complete message to the T-MN 510 along with the SN RRC Reconfiguration Complete Message. In some examples, once the T-MN 510 receives the condReconfigID from the UE 500, the T-MN 510 uses the mapping information from S7 and associates the condReconfigID with the relevant PSCell-ID.

At S14, the T-MN 510 transmits a SN Reconfiguration Complete message to the T-SN 506 associated with the selected configuration. For example, if the UE 500 has executed Config 2, i.e., CHO+CPAC for PSCell-1 where the PSCell-1 is associated with T-SN 1 506, the T-MN 510 sends the SN Reconfiguration Complete to T-SN 1 506.

At S15, the T-MN 510 transmits a Handover Success message to the S-MN 502. For example, the T-MN 510 informs the S-MN 502 about a successful completion of the handover procedure from S-MN 502 to T-MN 510.

At S16, SN Release, Path Switch and Data forwarding steps are performed.

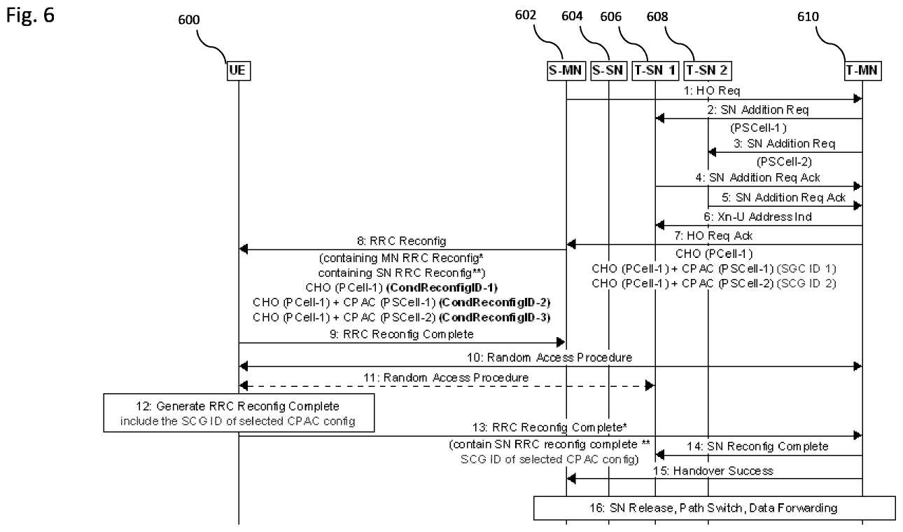

FIG. 6 shows another example of signalling between a user equipment and network entities In this example, a T-MN 610 assigns SCG IDs (or ‘SCG configuration ID’) for each CPAC configuration that is sent along with a CHO configuration. These SCG IDs are read by a UE 600 upon decoding the CHO configuration and SCG Configurations. In some examples, when a CHO+CPAC is executed, the UE 600 informs the T-MN 610 of the SCG ID. In some examples, when the T-MN 610 receives the SCG ID, the T-MN 610 associates SCG ID with the selected CPAC configurations, i.e., the PSCell IDs.

The SCG ID is an identity for a SCG that the T-MN assigns for each secondary cell group (SCG) configuration. Those SCG configurations are the configurations used for conditional PSCell addition/change. A difference between the ‘CondReconfigID’ and the ‘SCG ID’ is that, the CondReconfigID is used to manage the configuration given to the UE, i.e., add/release the configuration, update the condition of the given configuration. Instead, the SCG ID may be used in RRCReconfigurationComplete message to notify the T-MN about an executed configuration. This will be described in more detail below.

At S1, the S-MN 602 sends a HO Request to the T-MN 610.

At S2 and S3, the T-MN 610 prepares at least one PSCell and transmits the at least one PSCell to at least one T-SN 606, 608 in a SN Addition Request. In some examples, the T-MN prepares PSCell-1 and transmits this to T-SN 1 606 in a SN Addition Request for CPAC and/or the T-MN prepares PSCell-2 and transmits this to T-SN 2 608 in a SN Addition Request for CPAC. In some examples, CPAC may be configured along with the CHO configurations of the T-MN 610.

At S4 and S5, the at least one T-SN 606, 608 transmits a SN Addition Request Ack message to the T-MN 610.

At S6, the T-MN 610 transmits a Xn-U Address Indication message to at least one T-SN 606, 608.

At S7, the T-MN 610 transmits a HO Request Ack message to the S-MN 602. In some examples, the T-MN 610 generates 3 configurations and sends them to the S-MN 602 in the HO Request Ack message. In some examples, the configurations may be one or more of: Config 1; Config 2; Config3. In some examples, Config 1 comprises a CHO configuration (i.e., Config 1 may be for a single connectivity handover and may comprise PCell-1 but no CPAC or PSCell). In some examples, Config 2 comprises a CHO configuration of Pcell 1 and a CPAC configuration of PSCell 1 (i.e., Config 2 may be for a dual connectivity handover). In some examples, Config 3 comprises a CHO configuration of Pcell 1 and a CPAC configuration of PSCell 2 (i.e., Config 3 may be for a dual connectivity handover). In some examples, the CHO configurations in each configuration can be the same or different. In some examples, whether the CHO configurations in each configuration are the same or different depends on T-MN implementation. In some examples, the T-MN 610 assigns the SCG config 1D along with the CPAC configurations that are included in the CHO configuration. For example, the T-MN 610 may assign SCG ID 1 for PSCell-1 CPAC configuration in the CHO configuration of Config 2 and/or the T-MN 610 may assign SCG ID 2 for PSCell-2 CPAC configuration in the CHO configuration of Config 3.

At S8, the S-MN 602 generates a RRC Reconfiguration and transmits a RRC Reconfiguration message to the UE 600. In some examples, once the T-MN 610 provides the CHO configuration and CHO+CPAC configurations along with the Unique IDs to the S-MN 602, the S-MN 602 assigns the condReconfigIDs to those configurations and may keep the association in the S-MN 602 memory. In some examples, the S-MN 602 sends the configurations to the UE 600 with the S-MN's 602 assigned condReconfigIDs.

At S9, the UE 600 sends a RRC Reconfiguration Complete message to the S-MN 602. In some examples, the RRC Reconfiguration Complete is to indicate that the RRC Reconfiguration in S8 has been successfully received.

At S10 and S11, once one of the CHO+CPAC conditions are met, the UE 600 performs a Random-Access Procedure. For example, if Pcell-1 and one of the PSCell access conditions are met, the UE 600 handovers to Pcell-1 and the PSCell of which the access conditions have been met.

At S12, the UE 600 generates the RRC Reconfiguration Complete message for the executed configuration (for example, either Config 1, Config 2 or Config 3). In some examples, the UE 600 generates an RRC Reconfiguration Complete message for the T-MN's RRC Reconfiguration Complete message (for CHO) and the SN's RRC Reconfiguration Complete message (for CPAC). In some examples, the SN RRC Reconfiguration Complete message will be included in the RRC Reconfiguration Complete message. In some examples, the RRC Reconfiguration Complete is for the executed CHO configuration and may be read by the T-MN 610. In some examples the SN RRC

Reconfiguration Complete is for the executed CPAC configuration that may be read by the T-SN 606, 608. In some examples, once the UE 600 decodes the CHO configuration, the UE 600 reads the SCG config used for CPAC and reads the SCG ID configured along with the SCG config. 1n some examples, the UE 600 includes the SCG ID in the RRC Reconfiguration Complete* message that will be sent to the T-MN 610.

At S13, the UE 600 sends the RRC Reconfiguration Complete message to the T-MN 610 along with the SN RRC Reconfiguration Complete Message. In some examples, the T-MN reads the SCG ID that is configured in S7 so that the T-MN can associate the SCG ID and the relevant PSCell ID.

At S14, the T-MN 610 transmits a SN Reconfiguration Complete message to the T-SN 606 associated with the selected configuration. For example, if the UE 600 has executed Config 2, i.e., CHO+CPAC for PSCell-1 where the PSCell-1 is associated with T-SN 1 606, the T-MN 610 sends the SN Reconfiguration Complete to T-SN 1 606.

At S15, the T-MN 610 transmits a Handover Success message to the S-MN 602. For example, the T-MN 610 informs the S-MN 602 about a successful completion of the handover procedure from S-MN 602 to T-MN 610.

At S16, SN Release, Path Switch and Data forwarding steps are performed.

One or more of the examples discussed above have the advantage that a T-MN is able to determine which configuration for CHO/CPAC has been executed by the UE. Once the configuration is known, the T-MN will be able to provide data forwarding to the T-SN associated with the executed configuration and active data bearers. This can be done quickly as the T-MN does not need to wait for an indication of the configuration from the S-MN. Thus, there is the advantage of reduced latency.

Furthermore, based on the determined configuration that the UE has executed, the T-MN is able to initiate a release procedure towards one or more T-SNs that are not utilized in the configuration. This will ensure that resources are not wasted, and not reserves unnecessarily.

Furthermore, the size of the information provided in the RRCReconfigurationComplete message does not increased the bit size of the message, which means that additional resources are not needed to provide the information to the T-MN.

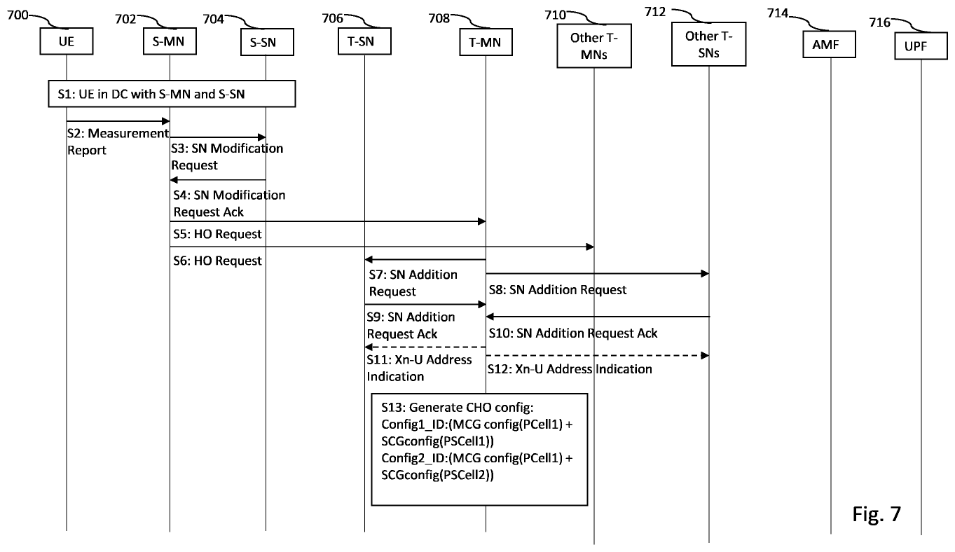

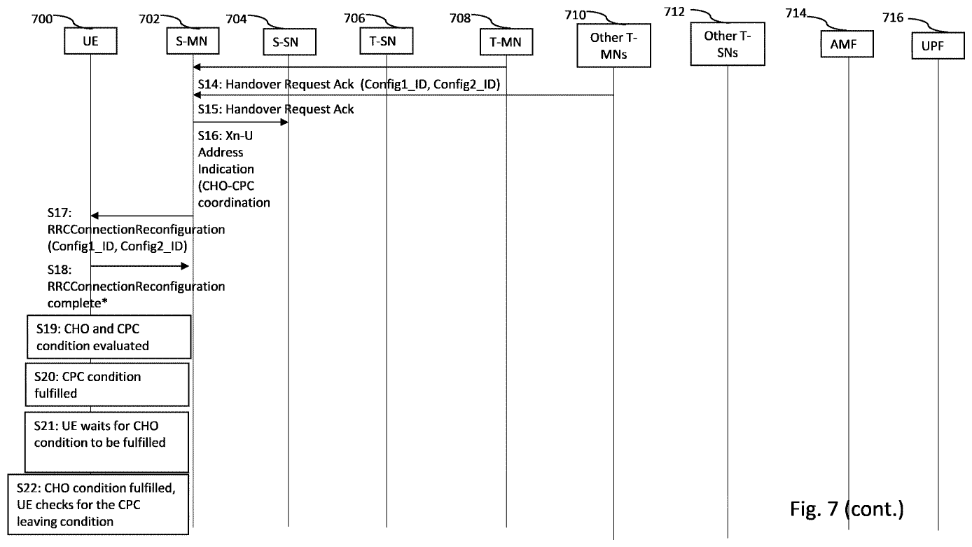

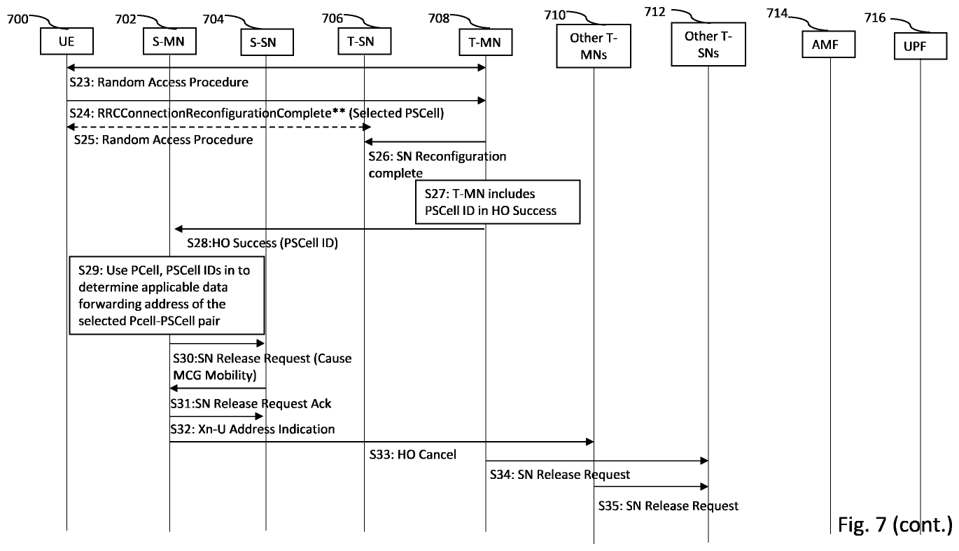

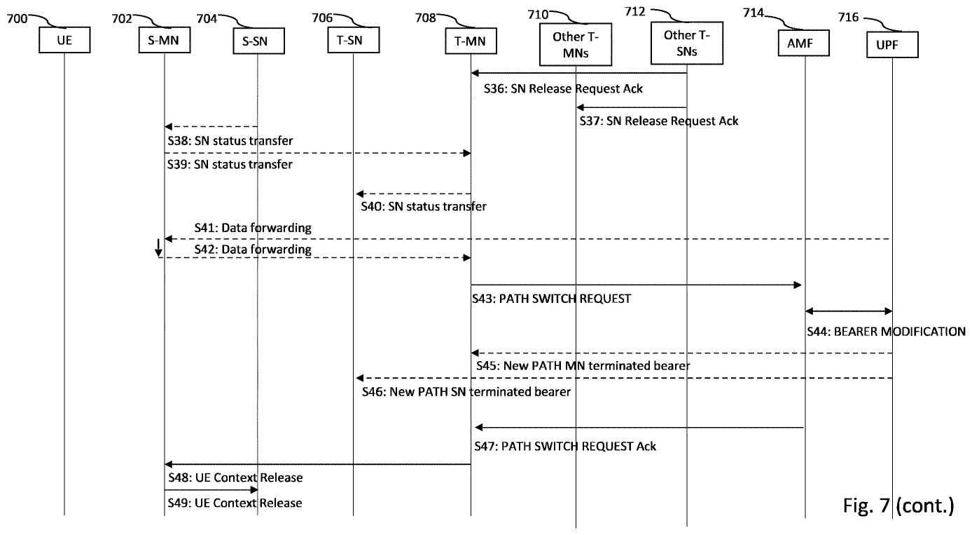

Some further examples described herein introduce a mechanism for addressing ambiguity at the S-MN for identifying the correct TEID related to a PCell-PSCell pair that the UE has applied. These further examples are described alongside FIGS. 7 to 9.

FIG. 7 shows another example of signalling between a user equipment and network entities.

In this example, a T-MN 708 may include cell ID information of the selected PSCell in the HO Success message along with the information of the selected PCell. In some examples, this enables an S-MN 702 to deduce the CHO configuration that the UE 700 has applied upon successful evaluation of CPC and CHO execution conditions and/or correctly fetch the TEID configuration of the selected PCell-PSCell pair.

In this example, at S1, the UE 700 may be in dual connectivity with S-MN 702 and S-SN 704.

At S2, the UE 700 may transmit a measurement report message to the S-MN 702. At S3, the S-MN 702 may transmit a SN Modification Request message to the S-SN 704.

At S4, the S-SN 704 may transmit a SN Modification Request Ack to the S-MN 702. At S5 and S6 the S-MN may transmit a HO Request message to the T-MN 708 and to other potential T-MNs 710.

At S7 and S8, the T-MN 708 may transmit a SN Addition Request to the T-SN 706 and/or to other potential T-SNs 712.

At S9 and S10, the T-SN 706 and/or other potential T-SNs 712 may transmit a SN Addition Request Ack to the T-MN 708.

At S11 and S12, the T-MN 708 may transmit a Xn-U Address Indication message to the T-SN 706 and/or to other potential T-SNs 712.

At S13, the T-MN 708 may generate a CHO configuration. In some examples, the T-MN 708 may generate Config 1 ID and/or Config2 ID. In some examples, Config 1 ID comprises an MCG configuration of PCell 1 and a SCG configuration of PSCell 1. In some examples, Config 2 ID comprises a MCG configuration of PCell 1 and a SCG configuration of PSCell 2.

At S14 and S15, the T-MN 708 and/or other potential T-MNs 710 may transmit a Handover Request Ack message to the S-MN 702. In some examples, the Handover Request Ack message comprises the configurations generated by the T-MN 708. For example, the Handover Request Ack comprises Config 1 ID and/or Config 2 ID.

At S16, the S-MN 702 may transmit a Xn-U Address Indication message to the S-SN 704. In some examples, the Xn-U Address Indication message comprises CHO-CPC coordination.

At S17, the S-MN 702 may transmit a RRC Connection Reconfiguration message to the UE 700. In some examples the RRC Connection Reconfiguration message comprises the configurations generated by the T-MN 708. For example, the RRC Connection Reconfiguration message may comprise Config 1 ID and/or Config 2 ID.

At S18, the UE 700 may transmit a RRC Connection Reconfiguration complete message to the S-MN 702.

At S19, the UE 700 may evaluate CHO and/or CPC conditions At S20, the UE 700 may determine whether the CPC condition is fulfilled.

At S21, the UE 700 may wait for the CHO condition to be fulfilled.

At S22, the UE 700 may check for the CPC leaving condition, once the CHO condition is fulfilled.

At S23, the UE 700 may perform a Random-Access procedure with the T-MN 708.

At S24, the UE 700 may transmit a RRC Connection Reconfiguration complete message to the T-MN 708 with information about the selected PSCell.

At S25, the UE 700 may perform a Random-Access procedure with the T-SN 706.

At S26, the T-MN 708 may transmit a SN Reconfiguration complete message to the T-SN 706.

At S27 the T-MN 708 may determine the cell ID of the selected PSCell (received in S24).

At S28, the T-MN 708 may transmit a HO Success message to the S-MN 702. In some examples, the cell ID determined in S27 may be included in the HO Success message. The present disclosure proposes a new IE for the HO Success IE. In some examples, information of the cell ID determined in S27 may be included in the new IE of the HO Success IE. The new IE is highlighted in bold in the below HO Success IE example:

HandoverSuccess-IEs XNAP-PROTOCOL-IES ::= {

| | | | |
|---|---|---|---|
| {ID id-sourceNG-RANnodeUEXnAPI | CRITICALITY | reject | TYPE NG- |
| RANnodeUEXnAPID | | | |
| PRESENCE mandatory}\| | | | |
| {ID id-targetNG-RANnodeUEXnAPID | CRITICALITY | reject | TYPE NG- |
| RANnodeUEXnAPID | | | |
| PRESENCE mandatory}\| | | | |
| {ID id-requestedTargetCellGlobalID | CRITICALITY | reject | TYPE Target-CGI |
| PRESENCE mandatory}, | | | |
| {ID id-requestedTargetCellGlobalID | CRITICALITY | reject | TYPE Target-CGI |
| PRESENCE mandatory}, | . . . | | |

}

At S29, the S-MN 702 may use the cell ID of the selected PCell and PScell (comprised in the new IE in the HO Success message as discussed at S28) to extract the data forwarding address of the selected PCell-PSCell pair.

At S30, the S-MN 702 may transmit a SN Release Request to the S-SN 704.

At S31, the S-SN 704 may transmit a SN Release Request Ack to the S-MN 702.

At S32, the S-MN 702 may transmit a Xn-U Address Indication message to the S-SN 704. In some examples, the extracted data forwarding information of the selected PCell-PSCell pair is included in the Xn-U Address Indication message. In some examples, the extracted data forwarding information of the selected PCell-PSCell pair is used by the S-SN 704 to initiate Data Forwarding of SCG bearers in case of late data forwarding. In some examples, in case of early data forwarding, the extracted data forwarding information of the selected PCell-PSCell pair is used by the S-SN 704 to step data forwarding to all other prepared PSCells other than the selected PSCell.

At S33, the S-MN 704 may transmit a HO Cancel message to the other potential T-MNs 710.

At S34, the T-MN 708 may transmit a SN Release Request message to the other potential T-SNs 712.

At S35, the other potential T-MNs 710 may transmit a SN Release Request message to the other potential T-SNs 712.

At S36 and S37, the other potential T-SNs 712 may transmit a SN Release Request

Ack message to the T-MN 708 and/or the other potential T-MNs 710.

At S38, the S-SN 704 may transmit a SN status transfer message to the S-MN 702.

At S39, the S-MN 702 may transmit a SN status transfer message to the T-MN 708.

At S40, the T-MN 708 may transmit a SN status transfer message to the T-SN 706.

At S41, the UPF 716 may perform data forwarding to the S-MN 702.

At S42, the S-MN 702 may perform data forwarding to the T-MN 708.

At S43, the T-MN 708 may transmit a Path Switch Request message to the AMF 714.

At S44, the AMF 714 and UPF 716 may perform bearer modification.

At S45, the UPF 716 may transmit a new path MN terminated bearer message to the T-MN 708.

At S46, the UPF 716 may transmit a new path SN terminated bearer message to the T-SN 706.

At S47, the AMF 714 may transmit a path switch request Ack message to the T-MN 708.

At S48, the T-MN 708 may transmit a UE Context Release message to the S-MN 702.

At S49, the S-MN 702 may transmit a UE Context Release message to the S-SN 704.

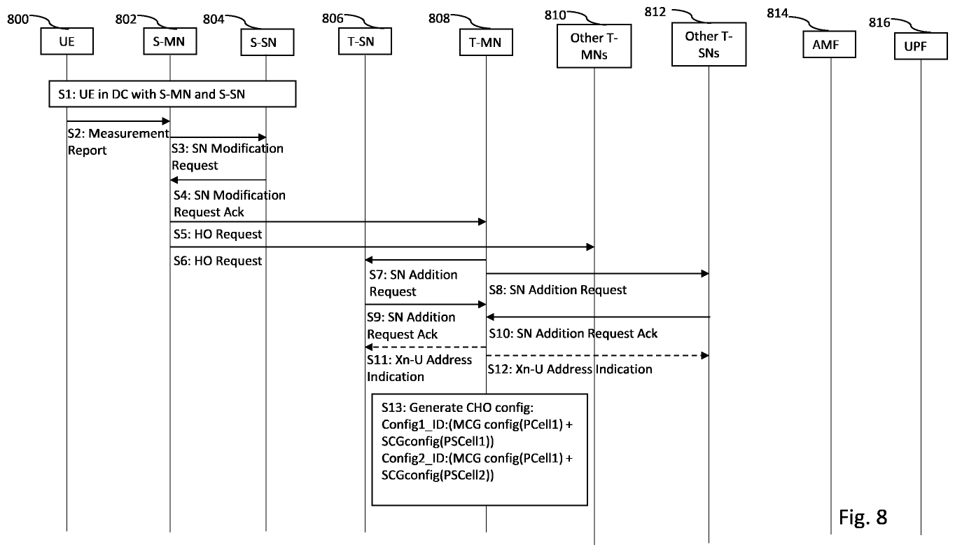

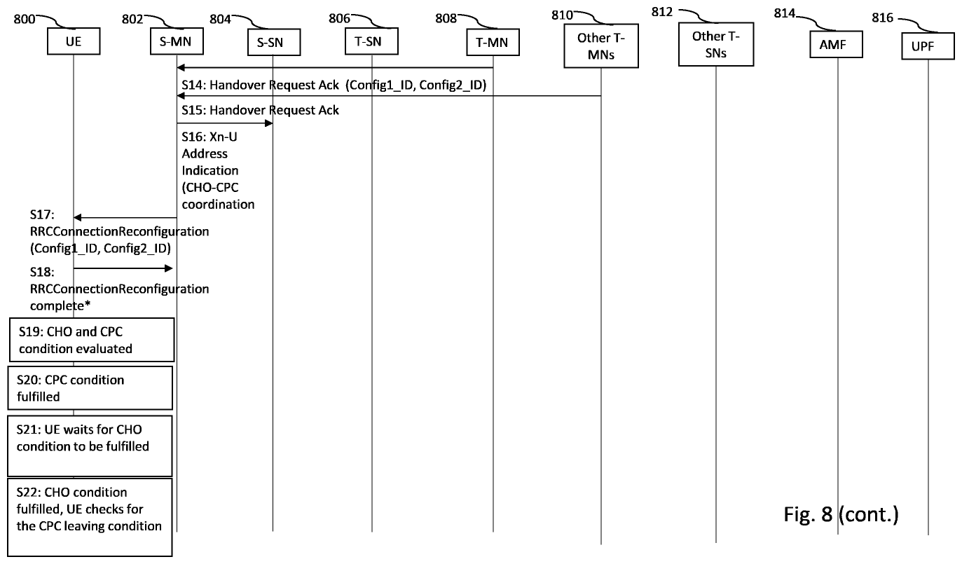

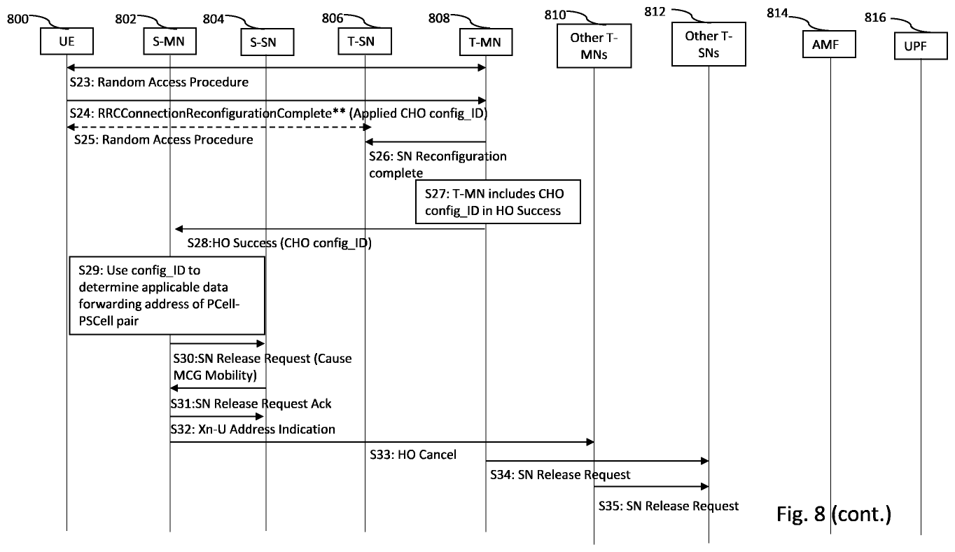

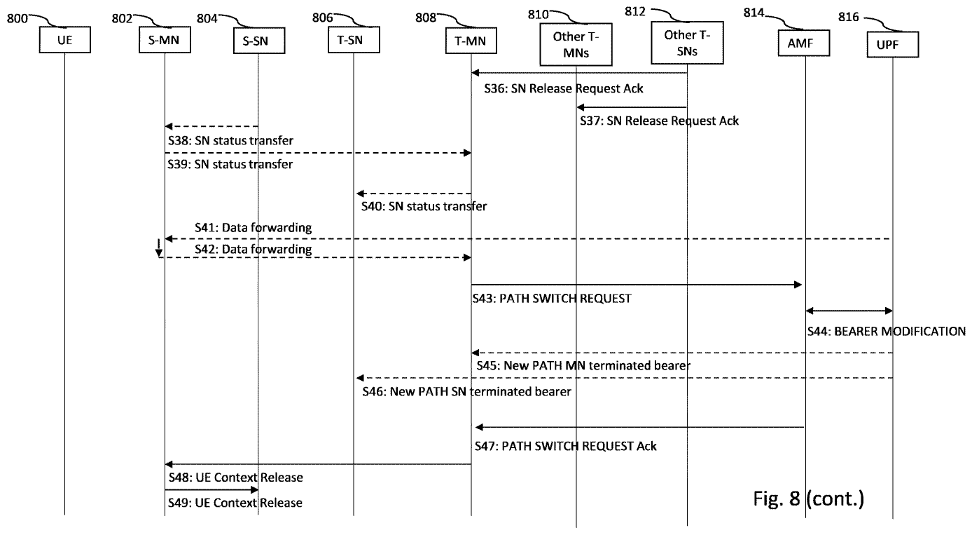

FIG. 8 shows another example of signalling between a user equipment and network entities.

In this example, a UE 800 may include the configuration ID of the applied CHO configuration in an RRC Reconfiguration Complete message after accessing the target cell.

In some examples, a T-MN 808 may include the received configuration ID in the HO Success message. In some examples, a S-MN 802 may use the received configuration ID to fetch the TEID setup of the selected PCell-PSCell pair.

In this example, at S1, the UE 800 may be in dual connectivity with S-MN 802 and S-SN 804.

At S2, the UE 800 may transmit a measurement report message to the S-MN 802.

At S3, the S-MN 802 may transmit a SN Modification Request message to the S-SN 804.

At S4, the S-SN 804 may transmit a SN Modification Request Ack to the S-MN 802.

At S5 and S6 the S-MN 802 may transmit a HO Request message to the T-MN 808 and to other potential T-MNs 810.

At S7 and S8, the T-MN 808 may transmit a SN Addition Request to the T-SN 806 and/or to other potential T-SNs 812.

At S9 and S10, the T-SN 806 and/or other potential T-SNs 812 may transmit a SN Addition Request Ack to the T-MN 808.

At S11 and S12, the T-MN 808 may transmit a Xn-U Address Indication message to the T-SN 806 and/or to other potential T-SNs 812.

At S13, the T-MN 808 may generate CHO configuration. In some examples, the T-MN 808 may generate Config 1 ID and/or Config 2 ID. In some examples, Config 1 ID comprises an MCG configuration of PCell 1 and a SCG configuration of PSCell 1. In some examples, Config 2 ID comprises an MCG configuration of PCell 1 and a SCG configuration of PSCell 2.

At S14 and S15, the T-MN 808 and/or other potential T-MNs 810 may transmit a Handover Request Ack message to the S-MN 802. In some examples, the Handover

Request Ack message comprises the configurations generated by the T-MN 808. For example, the Handover Request Ack comprises Config 1 ID and/or Config 2 ID.

At S16, the S-MN 802 may transmit a Xn-U Address Indication message to the S-SN 804. In some examples, the Xn-U Address Indication message comprises CHO-CPC coordination.

At S17, the S-MN 802 may transmit a RRC Connection Reconfiguration message to the UE 800. In some examples the RRC Connection Reconfiguration message comprises the configurations generated by the T-MN 808. For example, the RRC Connection Reconfiguration message may comprise Config 1 ID and/or Config 2 ID.

At S18, the UE 800 may transmit a RRC Connection Reconfiguration complete message to the S-MN 802.

At S19, the UE 800 may evaluate CHO and/or CPC conditions.

At S20, the UE 800 may determine whether the CPC condition is fulfilled.

At S21, the UE 800 may wait for the CHO condition to be fulfilled.

At S22, the UE 800 may check for the CPC leaving condition, once the CHO condition is fulfilled.

At S23, the UE 800 may perform a Random-Access procedure with the T-MN 808.

At S24, the UE 800 may transmit a RRC Connection Reconfiguration complete message to the T-MN 808. In some examples, after the UE 800 has successfully evaluated the CHO and CPC execution conditions, the UE 800 may include the applied Config 1Ds associated with the CHO configuration of the PCell-PSCell pair that it has accessed in the RRC Reconfiguration Complete message.

At S25, the UE 800 may perform a Random-Access procedure with the T-SN 806.

At S26, the T-MN 808 may transmit a SN Reconfiguration complete message to the T-SN 806.

At S27, the T-MN 808 may include the CHO Config 1D received in the RRC

Reconfiguration Complete message in the HO success message.

At S28, the T-MN 808 may transmit the HO success message with the CHO Config 1D to the S-MN 802. The present disclosure proposes a new IE for the HO Success message. The new IE is highlighted in bold in the below HO Success IE:

HandoverSuccess-IEs XNAP-PROTOCOL-IES ::= {

| | | | |
|---|---|---|---|
| {ID id-sourceNG-RANnodeUEXnAPI | CRITICALITY | reject | TYPE NG- |
| RANnodeUEXnAPID | | | |
| PRESENCE mandatory}\| | | | |
| {ID id-targetNG-RANnodeUEXnAPID | CRITICALITY | reject | TYPE NG- |
| RANnodeUEXnAPID | | | |
| PRESENCE mandatory}\| | | | |
| {ID id-requestedTargetCellGlobalID | CRITICALITY | reject | TYPE Target-CGI |
| PRESENCE mandatory}, | | | |
| {ID id-appliedConfigID | CRITICALITY | reject | TYPE CHO-ConfigID |
| PRESENCE mandatory}, | . . . | | |

}

At S29, the S-MN 802 may use the Config 1D (comprised in the new IE in the HO Success message as discussed at S28) to extract the data forwarding address of the selected PCell-PSCell pair.

At S30, the S-MN 802 may transmit a SN Release Request to the S-SN 804.

At S31, the S-SN 804 may transmit a SN Release Request Ack to the S-MN 802.

At S32, the S-MN 802 may transmit a Xn-U Address Indication message to the S-SN 804. In some examples, the extracted data forwarding information of the selected PCell-PSCell pair is included in the Xn-U Address Indication message. In some examples, the extracted data forwarding information of the selected PCell-PSCell pair is used by the S-SN 804 to initiate Data Forwarding of SCG bearers in case of late data forwarding. In some examples, in case of early data forwarding, the extracted data forwarding information of the selected PCell-PSCell pair is used by the S-SN 804 to step data forwarding to all other prepared PSCells other than the selected PSCell.

At S33, the S-MN 804 may transmit a HO Cancel message to the other potential T-MNs 810.

At S34, the T-MN 808 may transmit a SN Release Request message to the other potential T-SNs 812.

At S35, the other potential T-MNs 810 may transmit a SN Release Request message to the other potential T-SNs 812.

At S36 and S37, the other potential T-SNs 812 may transmit a SN Release Request

Ack message to the T-MN 808 and/or the other potential T-MNs 810.

At S38, the S-SN 804 may transmit a SN status transfer message to the S-MN 802.

At S39, the S-MN 802 may transmit a SN status transfer message to the T-MN 808.

At S40, the T-MN 808 may transmit a SN status transfer message to the T-SN 806.

At S41, the UPF 816 may perform data forwarding to the S-MN 802.

At S42, the S-MN 802 may perform data forwarding to the T-MN 808.

At S43, the T-MN 808 may transmit a Path Switch Request message to the AMF 814.

At S44, the AMF 814 and UPF 816 may perform bearer modification.

At S45, the UPF 816 may transmit a new path MN terminated bearer message to the T-MN 808.

At S46, the UPF 816 may transmit a new path SN terminated bearer message to the T-SN 806.

At S47, the AMF 814 may transmit a path switch request Ack message to the T-MN 808.

At S48, the T-MN 808 may transmit a UE Context Release message to the S-MN 802.

At S49, the S-MN 802 may transmit a UE Context Release message to the S-SN 804.

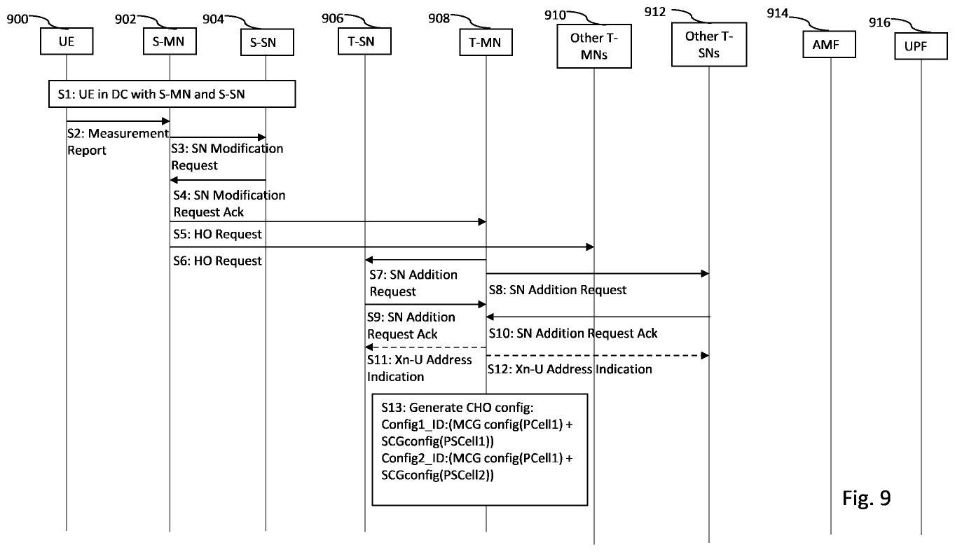

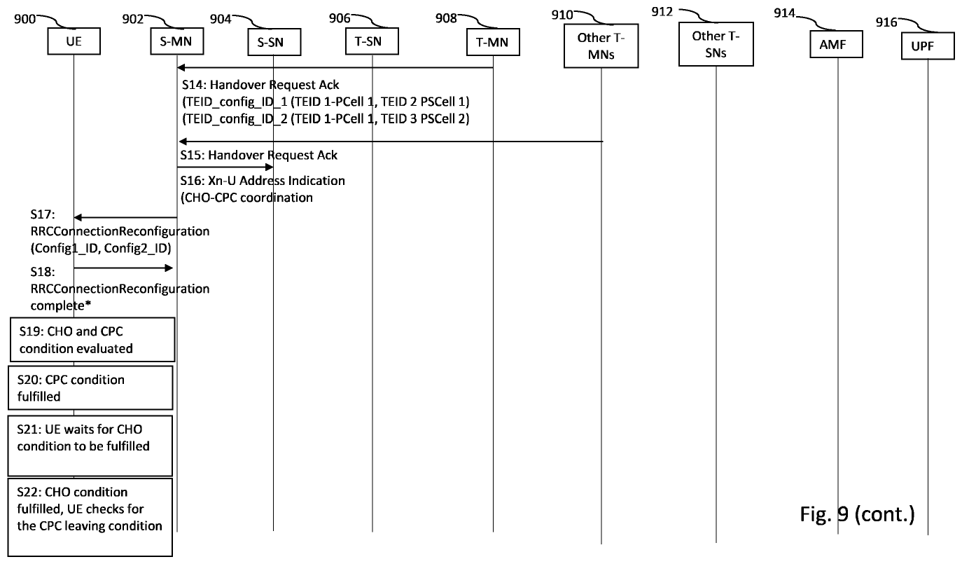

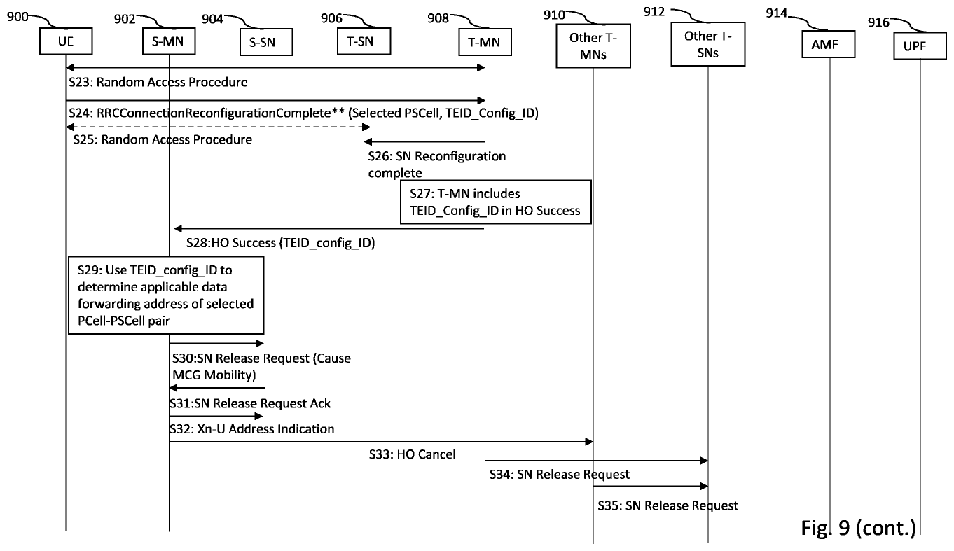

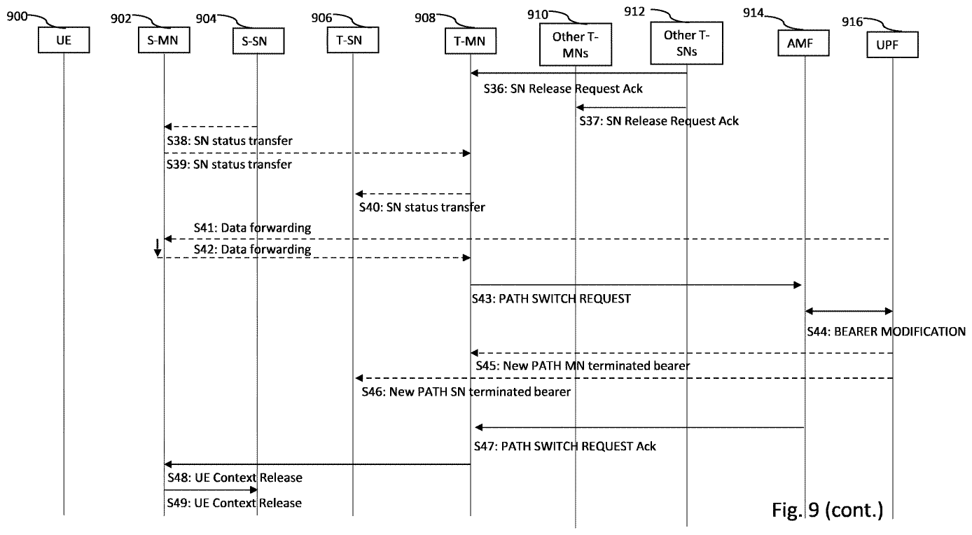

FIG. 9 shows another example of signalling between a user equipment and network entities.

In this example, a T-MN 908 may include a TEID_config_id (or DF_config_Id) i.e., a TEID (or DF) configuration associated with the CHO configuration of the prepared PCell-PSCell pair in the HO request Ack message. In some examples, the TEID_config_id (or DF_config_Id) may be included in the RRC Reconfiguration Complete message transmitted from a UE 900 to a T-MN 908 after accessing the target cell. In this example, the HO Success message may include the TEID_config_id (or DF_config_id). In some examples, a S-MN 902 may use the TEID_config_id (or DF_config_id) to fetch the correct data forwarding address.

In this example, at S1, the UE 900 may be in dual connectivity with S-MN 902 and S-SN 904.

At S2, the UE 900 may transmit a measurement report message to the S-MN 902.

At S3, the S-MN 902 may transmit a SN Modification Request message to the S-SN 904.

At S4, the S-SN 904 may transmit a SN Modification Request Ack to the S-MN 902.

At S5 and S6 the S-MN 902 may transmit a HO Request message to the T-MN 908 and to other potential T-MNs 910.

At S7 and S8, the T-MN 908 may transmit a SN Addition Request to the T-SN 906 and/or to other potential T-SNs 912.

At S9 and S10, the T-SN 906 and/or other potential T-SNs 912 may transmit a SN Addition Request Ack to the T-MN 908.

At S11 and S12, the T-MN 908 may transmit a Xn-U Address Indication message to the T-SN 906 and/or to other potential T-SNs 912.

At S13, the T-MN 908 may generate CHO configuration. In some examples, the T-MN 908 may generate Config 1 ID and/or Config 2 ID. In some examples, Config 1 ID comprises an MCG configuration of PCell 1 and a SCG configuration of PSCell 1. In some examples, Config 2 ID comprises an MCG configuration of PCell 1 and a SCG configuration of PSCell 2.

At S14, the T-MN 908 may transmit a HO Request Ack message to the S-MN 902. In some examples, the T-MN 908 may associate TEID_config (or DF_config) with each prepared CHO configuration of the PCell-PSCell pair and may identify the TEID_config (or DF_config) with an ID, for example with TEID_Config_Id (or DF_config_Id). In some examples, the T-MN 908 may include the TEID_Config_Ids (or DF_config_Ids) of the prepared PCell-PSCell pairs as new IEs in the HO Request Ack message.

At S15, the other potential T-MNs 910 may transmit a Handover Request Ack message to the S-MN 902.

At S16, the S-MN 902 may transmit a Xn-U Address Indication message to the S-SN 904. In some examples, the Xn-U Address Indication message comprises CHO-CPC coordination.

At S17, the S-MN 902 may transmit a RRC Connection Reconfiguration message to the UE 900. In some examples the RRC Connection Reconfiguration message comprises the configurations generated by the T-MN 908. For example, the RRC Connection Reconfiguration message may comprise Config 1 ID and/or Config 2 ID.

At S18, the UE 900 may transmit a RRC Connection Reconfiguration complete message to the S-MN 902.

At S19, the UE 900 may evaluate CHO and/or CPC conditions.

At S20, the UE 900 may determine whether the CPC condition is fulfilled.

At S21, the UE 800 may wait for the CHO condition to be fulfilled.

At S22, the UE 900 may check for the CPC leaving condition, once the CHO condition is fulfilled.

At S23, the UE 900 may perform a Random-Access procedure with the T-MN 808.

At S24, the UE 900 may transmit a RRC Connection Reconfiguration complete message to the T-MN 908. In some examples, after a successful evaluation of CHO and CPC execution conditions, the UE 900 may include the applied TEID_config_Id (or DF_config_Id) associated with the CHO configuration of the PCell-PSCell pair that it has accessed in the RRC Reconfiguration Complete message.

At S25, the UE 900 may perform a Random-Access procedure with the T-SN 906. At S26, the T-MN 908 may transmit a SN Reconfiguration complete message to the T-SN 906.

At S27, the T-MN 908 may include the TEID_config_Id (or DF_config_Id) in the HO Success message.

At S28, the T-MN 908 may transmit the HO success message with the TEID_config_Id (or DF_config_Id) to the S-MN 902. The present disclosure proposes a new IE for the HO Success message. The new IE is highlighted in bold in the below HO Success IE:

HandoverSuccess-IEs XNAP-PROTOCOL-IES ::= {

| | | | |
|---|---|---|---|
| {ID id-sourceNG-RANnodeUEXnAPI | CRITICALITY | reject | TYPE NG- |
| RANnodeUEXnAPID | | | |
| PRESENCE mandatory}\| | | | |
| {ID id-targetNG-RANnodeUEXnAPID | CRITICALITY | reject | TYPE NG- |
| RANnodeUEXnAPID | | | |
| PRESENCE mandatory}\| | | | |
| {ID id-requestedTargetCellGlobalID | CRITICALITY | reject | TYPE Target-CGI |
| PRESENCE mandatory}, | | | |
| {ID id-appliedDFConfigID | CRITICALITY | reject | TYPE DF-ConfigID |
| PRESENCE mandatory}, | . . . | | |
| } | | | |

At S29, the S-MN 902 may use the Config 1D (comprised in the new IE in the HO Success message as discussed at S28) to extract the data forwarding address of the selected PCell-PSCell pair.

At S30, the S-MN 902 may transmit a SN Release Request to the S-SN 904.

At S31, the S-SN 904 may transmit a SN Release Request Ack to the S-MN 902.

At S32, the S-MN 902 may transmit a Xn-U Address Indication message to the S-SN 904. In some examples, the extracted data forwarding information of the selected PCell-PSCell pair is included in the Xn-U Address Indication message. In some examples, the extracted data forwarding information of the selected PCell-PSCell pair is used by the S-SN 904 to initiate Data Forwarding of SCG bearers in case of late data forwarding. In some examples, in case of early data forwarding, the extracted data forwarding information of the selected PCell-PSCell pair is used by the S-SN 904 to step data forwarding to all other prepared PSCells other than the selected PSCell.

At S33, the S-MN 904 may transmit a HO Cancel message to the other potential T-MNs 910.

At S34, the T-MN 908 may transmit a SN Release Request message to the other potential T-SNs 912.

At S35, the other potential T-MNs 910 may transmit a SN Release Request message to the other potential T-SNs 912.

At S36 and S37, the other potential T-SNs 912 may transmit a SN Release Request

Ack message to the T-MN 908 and/or the other potential T-MNs 910.

At S38, the S-SN 904 may transmit a SN status transfer message to the S-MN 902. At S39, the S-MN 902 may transmit a SN status transfer message to the T-MN 908.

At S40, the T-MN 908 may transmit a SN status transfer message to the T-SN 906.

At S41, the UPF 916 may perform data forwarding to the S-MN 902.

At S42, the S-MN 902 may perform data forwarding to the T-MN 908.

At S43, the T-MN 908 may transmit a Path Switch Request message to the AMF 914.

At S44, the AMF 914 and UPF 916 may perform bearer modification.

At S45, the UPF 916 may transmit a new path MN terminated bearer message to the T-MN 908.

At S46, the UPF 916 may transmit a new path SN terminated bearer message to the T-SN 906.

At S47, the AMF 914 may transmit a path switch request Ack message to the T-MN 908.

At S48, the T-MN 908 may transmit a UE Context Release message to the S-MN 902.

At S49, the S-MN 902 may transmit a UE Context Release message to the S-SN 904.

In some examples, the following embodiments can be applied to Embodiments 4, 5 and 6 of the present disclosure. In some examples, if the bearer is reconfigured, the PDU session configuration of the UE for a target PSCell is updated, and the config_id and indicated TEIDs mapping to different bearers can be accordingly updated. In some examples, if there are different configurations for carrier aggregation with PCell and PSCell, the data that is to be communicated over the SCell can be forwarded to the RAN node that controls the PCell or the PSCell. This can be indicated in different TEID configurations (e.g., via an associated config id). At the time of handover execution, this can be indicated to the S-MN so that the S-MN can perform the correct TEID based forwarding. In some examples, if there are different multi-TRP configurations for the UE with the PCell or PSCell, the data that is to be communicated over the PCell or PSCell may vary (e.g., the mTRP may provide higher throughput). This can be indicated in different TEID configurations (e.g., via a config 1d). At the time of handover execution, this can be indicated to the S-MN so that the S-MN can perform the correct TEID based forwarding. In some examples, if there are different DRB configurations for the UE with the same PCell or PSCell, the data that is to be communicated over the PCell or PSCell may vary (e.g., the radio conditions of the PCell/PSCell might be too good such that more DRBs can be supported by the PCell/PSCell. PCell/PSCell load may vary which can enable a different number of DRBs to be supported by the PCell/PSCell. This can be indicated in different TEID configurations (e.g., via a config 1d). At the time of handover execution, this can be indicated to the S-MN so that the S-MN can perform the correct TEID based forwarding.

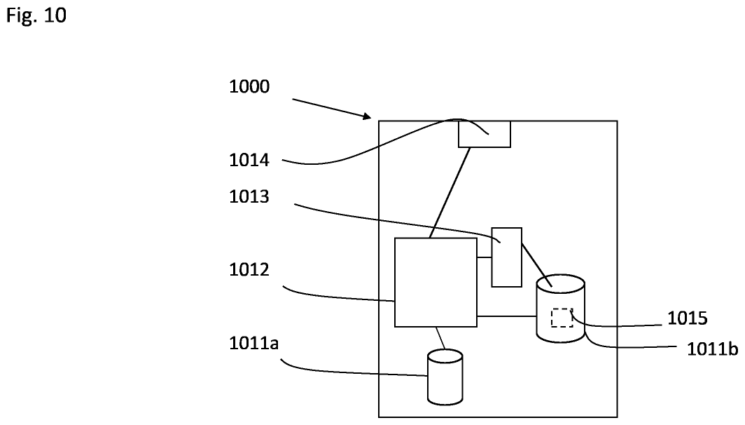

Advantages the examples described in FIGS. 7 to 9 include, in case of CHO with a SN/SCG change, a solution for the Data Forwarding of SCG bearers in case of late data forwarding. In some examples, in case of early data forwarding, the examples ensure that early data forwarding to other prepared SNs stop on receiving the correct TEID configuration information of the selected PCell-PSCell pair in the Xn-U Address Indication message. FIG. 10 illustrates an example of an apparatus 1000, herein referred to as a ‘control apparatus’ 1000 for controlling a function of a network entity, such as the 5GRAN or the 5GC as illustrated on FIG. 1. The apparatus 1000 may be comprised in an MN or SN, as disclosed in the examples above. The control apparatus may comprise at least one random access memory (RAM) 1011a, at least on read only memory (ROM) 1011b, at least one processor 1012, 1013 and an input/output interface 1014. The at least one processor 1012, 1013 may be coupled to the RAM 1011a and the ROM 1011b. The at least one processor 1012, 1013 may be configured to execute an appropriate software code 1015. The software code 1015 may for example allow to perform one or more steps to perform one or more of the present aspects. The software code 1015 may be stored in the ROM 1011b. The control apparatus 1000 may be interconnected with another control apparatus 1000 controlling another function of the 5GRAN or the 5GC. In some embodiments, each function of the 5GRAN or the 5GC comprises a control apparatus 1000. In alternative embodiments, two or more functions of the 5GRAN or the 5GC may share a control apparatus.

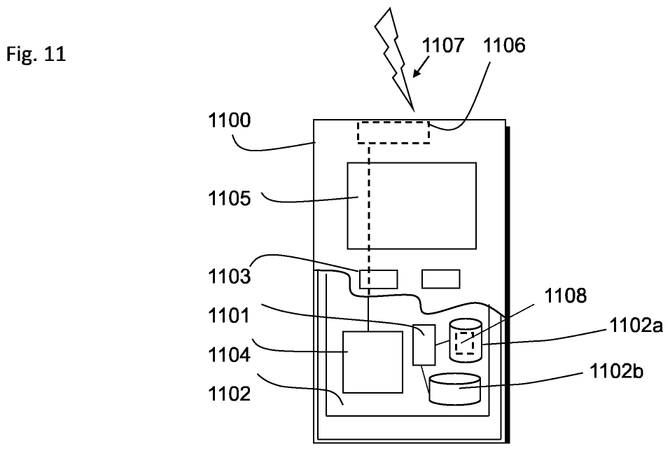

FIG. 11 illustrates an example of a terminal 1100, such as the terminal illustrated on FIG. 1. The terminal 1100 may be provided by any device capable of sending and receiving radio signals. Non-limiting examples comprise a user equipment (such as the UE disclosed in the examples above), a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 1100 may provide, for example, communication of data for carrying communications. The communications may be one or more of voice, electronic mail (email), text message, multimedia, data, machine data and so on.

The terminal 1100 may be provided with at least one processor 1101, at least one memory ROM 1102a, at least one RAM 1102b and other possible components 1103 for use in software and hardware aided execution of tasks it is designed to perform, including control of access to and communications with access systems and other communication devices. The at least one processor 1101 is coupled to the RAM 1102b and the ROM 1102a. The at least one processor 1101 may be configured to execute an appropriate software code 1108. The software code 1108 may for example allow to perform one or more of the present aspects. The software code 1108 may be stored in the ROM 1102a.

The processor, storage and other relevant control apparatus can be provided on an appropriate circuit board and/or in chipsets. This feature is denoted by reference 1104. The device may optionally have a user interface such as key pad 1105, touch sensitive screen or pad, combinations thereof or the like. Optionally one or more of a display, a speaker and a microphone may be provided depending on the type of the device.

The terminal 1100 may receive signals over an air or radio interface 1107 via appropriate apparatus for receiving and may transmit signals via appropriate apparatus for transmitting radio signals. In FIG. 11 transceiver apparatus is designated schematically by block 1106. The transceiver apparatus 1106 may be provided for example by means of a radio part and associated antenna arrangement. The antenna arrangement may be arranged internally or externally to the mobile device.

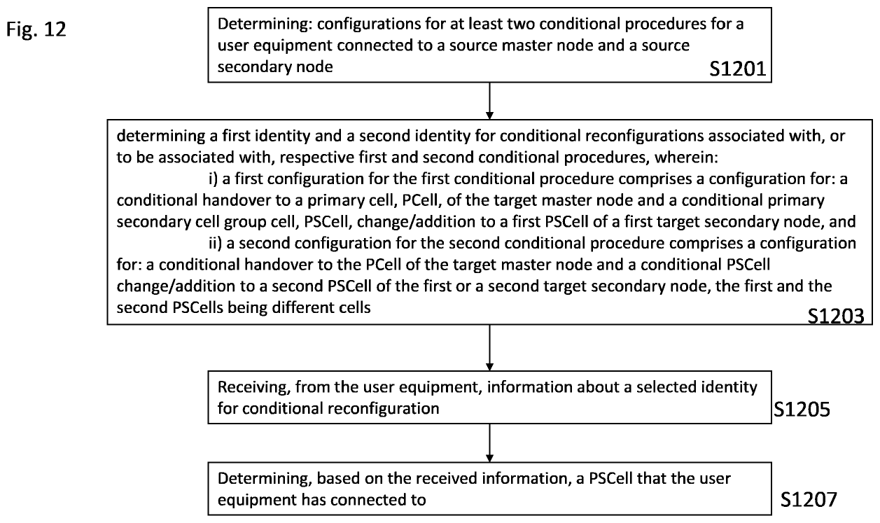

FIG. 12 shows an example method flow performed by an apparatus. The apparatus may be comprised within a base station. The apparatus may be for a base station. The apparatus may be a base station. In some examples, the base station is configured as a target master node.

In S1201, the method comprises determining: configurations for at least two conditional procedures for a user equipment connected to a source master node and a source secondary node.

In S1203, the method comprises determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells.

In S1205, the method comprises receiving, from the user equipment, information about a selected identity for conditional reconfiguration.

In S1207, the method comprises determining, based on the received information, a PSCell that the user equipment has connected to.

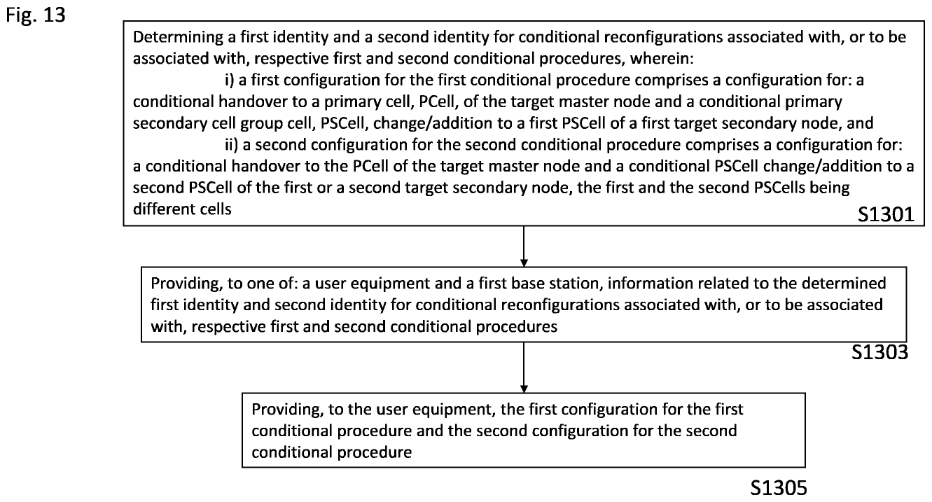

FIG. 13 shows an example method flow performed by an apparatus. The apparatus may be comprised within a base station. The apparatus may be for a base station. The apparatus may be a base station. In some examples, the base station is configured as a source master node.

In S1301, the method comprises determining a first identity and a second identity for conditional reconfigurations associated with, or to be associated with, respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells.

In S1303, the method comprises providing, to one of: a user equipment and a first base station, information related to the determined first identity and second identity for conditional reconfigurations associated with, or to be associated with, respective first and second conditional procedures.

In S1305, the method comprises providing, to the user equipment, the first configuration for the first conditional procedure and the second configuration for the second conditional procedure.

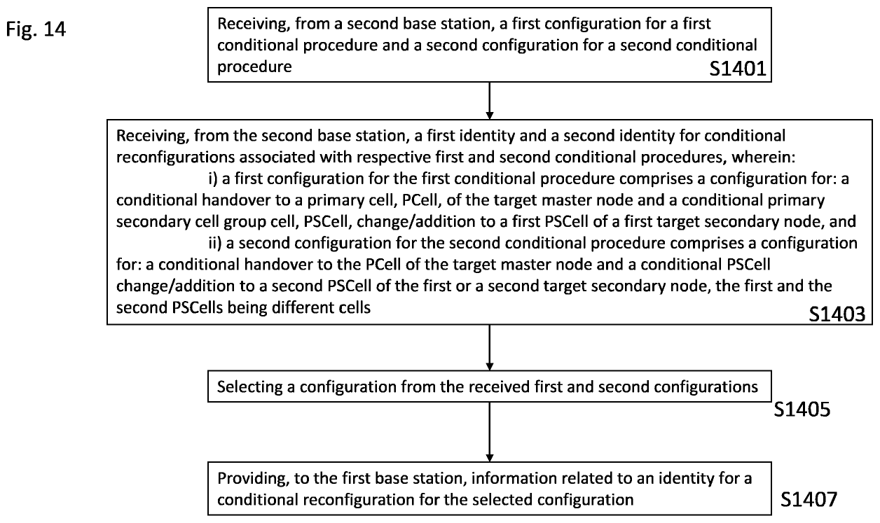

FIG. 14 shows an example method flow performed by an apparatus. The apparatus may be comprised within a user equipment or terminal. The apparatus may be for a user equipment or terminal. The apparatus may be a user equipment or terminal. In some examples, the user equipment/terminal is connected to a S-MN and S-SN (before a CHO/CPAC).

In S1401, the method comprises receiving, from a second base station, a first configuration for a first conditional procedure and a second configuration for a second conditional procedure.

In S1403, the method comprises receiving, from the second base station, a first identity and a second identity for conditional reconfigurations associated with respective first and second conditional procedures, wherein: i) a first configuration for the first conditional procedure comprises a configuration for: a conditional handover to a primary cell, PCell, of the target master node and a conditional primary secondary cell group cell, PSCell, change/addition to a first PSCell of a first target secondary node, and ii) a second configuration for the second conditional procedure comprises a configuration for: a conditional handover to the PCell of the target master node and a conditional PSCell change/addition to a second PSCell of the first or a second target secondary node, the first and the second PSCells being different cells.

In S1405, the method comprises selecting a configuration from the received first and second configurations.

In S1407, the method comprises providing, to the first base station, information related to an identity for a conditional reconfiguration for the selected configuration.

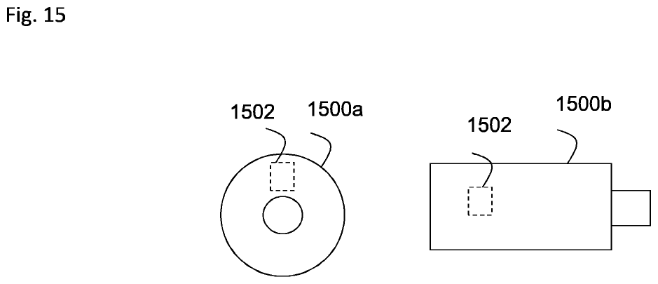

FIG. 15 shows a schematic representation of non-volatile memory media 1500a (e.g. computer disc (CD) or digital versatile disc (DVD)) and 1500b (e.g. universal serial bus (USB) memory stick) storing instructions and/or parameters 1502 which when executed by a processor allow the processor to perform one or more of the steps of the method of FIGS. 12 to 14.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, or means, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” or “means” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-37. (canceled)

38. An apparatus for a target master node, the apparatus comprising at least one processor; and at least one memory storing instructions that, when executed by the at least one processor, cause the apparatus at least to:
determine configurations for at least two conditional procedures for a user equipment connected to a source master node and a source secondary node;
determine a first identity and a second identity for conditional reconfigurations associated with, or to be associated with, respective first and second conditional procedures, wherein:
i) a first configuration for the first conditional procedure comprises a configuration for: a conditional handover to a primary cell, PCell, of the target master node and a conditional primary secondary cell group cell, PSCell, change/addition to a first PSCell of a first target secondary node, and
ii) a second configuration for the second conditional procedure comprises a configuration for: a conditional handover to the PCell of the target master node and a conditional PSCell change/addition to a second PSCell of the first or a second target secondary node, the first and the second PSCells being different cells;
receive, from the user equipment, information about a selected identity for conditional reconfiguration; and
determe, based on the received information, a PSCell that the user equipment has connected to; wherein the determining a first identity and a second identity for conditional reconfigurations associated with, or to be associated with, respective first and second conditional procedures comprises:
providing, to a second base station, first information indicating that: the first configuration is for a conditional PSCell change/addition to the first PSCell, and the second configuration is for a conditional PSCell change/addition to the second PSCell; and
receiving, from the second base station, second information indicating that the first configuration is associated with the first identity, and the second configuration is associated with the second identity.

39. The apparatus according to claim 38, wherein the determining associations comprises:
providing, to a second base station, a unique identity for each of the first and second configurations; and
receiving, from the second base station, a mapping between the unique identities and the first and second identities for conditional reconfigurations.

40. The apparatus according to claim 38, wherein the determining associations comprises:
receiving, from a second base station, the first and second identities for conditional reconfigurations;
determining a mapping between the first and second identities for conditional reconfigurations and unique identities; and
providing the mapping to the second base station.

41. The apparatus according to claim 38, wherein the determining the PSCell comprises:
determining, based on the mapping and the received information, the PSCell that the user equipment has connected to.

42. An apparatus for a source master node, the apparatus comprising: at least one processor; and at least one memory storing instructions that, when executed by the at least one processor, cause the apparatus at least to:
determine a first identity and a second identity for conditional reconfigurations associated with, or to be associated with, respective first and second conditional procedures, wherein:
i) a first configuration for the first conditional procedure comprises a configuration for: a conditional handover to a primary cell, PCell, of the target master node and a conditional primary secondary cell group cell, PSCell, change/addition to a first PSCell of a first target secondary node, and
ii) a second configuration for the second conditional procedure comprises a configuration for: a conditional handover to the PCell of the target master node and a conditional PSCell change/addition to a second PSCell of the first or a second target secondary node, the first and the second PSCells being different cells;
provide, to one of: a user equipment and a first base station, information related to the determined first identity and second identity for conditional reconfigurations associated with, or to be associated with, respective first and second conditional procedures; and
provide, to the user equipment, the first configuration for the first conditional procedure and the second configuration for the second conditional procedure; wherein the determining a first identity and a second identity for conditional reconfigurations associated with, or to be associated with, respective first and second conditional procedures comprises:
receiving, from the first base station, first information indicating that: the first configuration is for a conditional PSCell change/addition to the first PSCell, and the second configuration is for a conditional PSCell change/addition to the second PSCell; and
providing, to the first base station, second information indicating that the first configuration is associated with the first identity, and the second configuration is associated with the second identity.

43. The apparatus according to claim 42, wherein the determining associations comprises:
receiving, from the first base station, a unique identity for each of the first and second configurations; and
providing, to the first base station, a mapping between the unique identities and the first and second identities for conditional reconfigurations.

44. The apparatus according to claim 42, the apparatus is further caused to:
provide, to the first base station, the first and second identities for first and second conditional reconfigurations; and
receive, from the first base station, a mapping between the first and second identities and unique identities.

45. An apparatus for a user equipment, wherein the user equipment is connected to a source master node and a source secondary node, the apparatus comprising at least one processor; and at least one memory storing instructions that, when executed by the at least one processor, cause the apparatus at least to:
receive, from a second base station, a first configuration for a first conditional procedure and a second configuration for a second conditional procedure;
receive, from the second base station, a first identity and a second identity for conditional reconfigurations associated with respective first and second conditional procedures, wherein:
i) a first configuration for the first conditional procedure comprises a configuration for: a conditional handover to a primary cell, PCell, of the target master node and a conditional primary secondary cell group cell, PSCell, change/addition to a first PSCell of a first target secondary node, and
ii) a second configuration for the second conditional procedure comprises a configuration for: a conditional handover to the PCell of the target master node and a conditional PSCell change/addition to a second PSCell of the first or a second target secondary node, the first and the second PSCells being different cells;
select a configuration from the received first and second configurations; and
provide, to the first base station, information related to an identity for a conditional reconfiguration for the selected configuration.

46. The apparatus according to claim 45, wherein each of the first and second configurations comprises a configuration for: a conditional handover, and at least two conditional PSCell change/additions.

47. The apparatus according to claim 45, wherein the apparatus is further caused to:
generate a radio resource control reconfiguration complete message; and
provide the radio resource control reconfiguration complete message comprising the information related to an identity for a conditional reconfiguration for the selected configuration.

48. The apparatus according to claim 45, wherein the information comprises one of: an identity for a conditional reconfiguration, and a secondary cell group identity.

49. The apparatus according to claim 45, wherein one of: the apparatus is for the user equipment, the apparatus is comprised in the user equipment, and the apparatus is the user equipment.
